(19) United States
(12) Patent Application Publication
(10) Pub. No.: US 2024/0283211 A1
(43) Pub. Date: Aug. 22, 2024

(54) COMPACT MICRORING SCHEME FOR CHIP LASER INJECTION LOCKING AND OPTICAL PARAMETRIC OSCILLATION

(71) Applicants: University of Maryland, College Park, College Park, MD (US); Government of the United States of America, as Represented by the Secretary of Commerce, Gaithersburg, MD (US); University of Massachusetts, Hadley, MA (US)

(72) Inventors: Xiyuan LU, Montgomery Village, MD (US); Kartik SRINIVASAN, Gaithersburg, MD (US); Andrew MCCLUNG, Florence, MA (US)

(21) Appl. No.: 18/582,916

(22) Filed: Feb. 21, 2024

Related U.S. Application Data
(60) Provisional application No. 63/447,440, filed on Feb. 22, 2023.

(51) Int. Cl. H01S 3/108; H01S 3/06; H01S 3/10

(52) U.S. Cl. CPC H01S 3/1083; H01S 3/0627; H01S 3/10092

(57) ABSTRACT

A system for injection locking, including a light source configured to pump a first color light and a device configured to enable injection locking. The device includes a waveguide configured to couple to the light source and a microring resonator coupled to the light source via the waveguide. The microring resonator is a photonic crystal ring configured to enable injection locking. The microring resonator is configured to operate at a bandgap closing point, where reflection at a single frequency occurs.

### CROSS-REFERENCE TO RELATED APPLICATIONS AND CLAIM OF PRIORITY

This application claims the benefit of, and priority to, U.S. Provisional Patent Application No. 63/447,440, filed on Feb. 22, 2023, the entire contents of which are hereby incorporated herein by reference.

### GOVERNMENT SUPPORT

This invention was made with government support under 70NANB16H168 awarded by the National Institute of Standards and Technology. The government has certain rights in the invention.

### TECHNICAL FIELD

The present disclosure relates generally to the field of on-chip optical parametric oscillation (“OPO”) and laser injection locking. More specifically, the present disclosure provides systems and methods for generating coherent laser light.

### BACKGROUND

Many applications in quantum information science, metrology, and sensing require access to coherent laser light at a variety of wavelengths, ideally in a chip-integrated format suitable for scalable fabrication and deployment. While integrated photonics lasers are highly developed in the telecommunications band, many of the aforementioned technologies operate at other wavelengths. To this end, the extension of heterogeneously integrated lasers to other bands has been pursued, with recent demonstrations at 980 nm and 2000 nm. However, wavelength access across the entirety of a broad spectral range would demand the challenging integration of several material platforms.

Accordingly, there is interest in enabling flexible coherent light generation across a broad range of wavelengths.

### SUMMARY

An aspect of the present disclosure provides a system for injection locking. The system includes a light source configured to pump a first color light and a device configured to enable injection locking. The device includes a waveguide configured to couple to the light source and a microring resonator coupled to the light source via the waveguide. The microring resonator is a photonic crystal ring configured to enable injection locking. The microring resonator is configured to operate at a bandgap closing point, where reflection at a single frequency occurs.

In accordance with aspects of the disclosure, the microring resonator may be configured to generate a coherent second color light and a coherent third color light.

In accordance with aspects of the disclosure, the generation of the coherent second color light and the coherent third color light may be based on optical parametric oscillation.

In accordance with aspects of the disclosure, the coherent second color light and the coherent third color light may be a different color than the first color light.

In accordance with aspects of the disclosure, the optical parametric oscillation and the injection locking may be performed on a same device.

In accordance with aspects of the disclosure, the microring resonator may include a layer comprised of silicon nitride, a substrate comprised of silicon dioxide disposed on the second side of the layer, and a cladding comprised of air disposed on the first side of the layer. The layer may include a ring width, a first side, and a second side.

In another aspect of the present disclosure, the microring resonator and the waveguide may be on a common substrate.

In another aspect of the present disclosure, the waveguide may output a signal wave including a signal mode and an idler wave including an idler mode.

In another aspect of the present disclosure, the first color light may include a pump mode.

In yet another aspect of the present disclosure, the photonic crystal ring may include a grating as a photonic crystal structure.

In another aspect of the present disclosure, the grating includes periodical modulation in one dimension.

In another aspect of the present disclosure, the optical parametric oscillation and the injection locking may be performed on the same device.

In accordance with aspects of the disclosure, the microring resonator may include rods, slits, and/or microgears.

In accordance with further aspects of the present disclosure, a device configured to generate a coherent second color light and a coherent third color light is presented. The device includes a waveguide configured to couple to a light source and a microring resonator coupled to the light source via the waveguide. The microring resonator is configured to generate a coherent second color light and a coherent third color light. The microring resonator includes unit cells

In an aspect of the present disclosure, the generation of the coherent second color light and the coherent third color light may be based on optical parametric oscillation.

In an aspect of the present disclosure, the microring resonator may be configured for injection locking and to operate at a bandgap closing point, where reflection at a single frequency occurs.

In an aspect of the present disclosure, the photonic crystal ring may include a grating as a photonic crystal structure.

In an aspect of the present disclosure, the grating includes periodical modulation in one dimension.

In an aspect of the present disclosure, the microring resonator may include a substrate comprised of silicon dioxide disposed on a second side of the unit cells; and a cladding comprised of air disposed on a first side of the unit cells.

In an aspect of the present disclosure, the unit cells may be comprised of a material with an index of refraction higher than an index of refraction of the substrate.

In an aspect of the present disclosure, the microring resonator and the waveguide are on a common substrate.

In an aspect of the present disclosure, the microring resonator includes a grating as a photonic crystal structure.

In accordance with further aspects of the present disclosure, a device configured to enable injection locking is presented. The device includes a waveguide configured to couple to a light source and a photonic crystal ring configured to enable injection locking, the photonic crystal ring coupled to a light source via the waveguide. The photonic crystal ring is configured to operate at a bandgap closing point, where reflection at a single frequency occurs.

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a diagram of an exemplary device for generating a coherent laser light, in accordance with examples of the present disclosure;

FIG. 2 is a diagram of an exemplary system for on-chip injection locking using the device of FIG. 1, in accordance with examples of the present disclosure;

FIG. 3 is a series of wave signal graphs for the system of FIG. 2, in accordance with examples of the present disclosure;

FIG. 4 is a diagram of an exemplary system for on-chip injection locking using the device of FIG. 1, in accordance with examples of the present disclosure;

FIG. 5 is a series of wave signal graphs for the system of FIG. 4, in accordance with examples of the present disclosure;

FIGS. 6-11 are graphs illustrating band flipping and bandgap closing behavior, in accordance with examples of the present disclosure;

FIG. 12 is a diagram of a photonic crystal ring (PhCR) manipulating a laser diode for laser injection locking and optical parametric oscillation, in accordance with examples of the present disclosure;

FIG. 13 is a molecular diagram of the PhCR, in accordance with examples of the present disclosure;

FIG. 14 is a diagram of an example PhCR device, in accordance with examples of the present disclosure;

FIG. 15 is a diagram of a laser input and optical parametric oscillation output of the PhCR, in accordance with examples of the present disclosure;

FIG. 16 is a diagram of a laser input and optical parametric oscillation output with a visible light spectrum, in accordance with examples of the present disclosure;

FIG. 17 is a band diagram for the PhCR of cavity quantum electrodynamics (cQED), in accordance with examples of the present disclosure;

FIG. 18 is an illustration of the spatial electric field profiles of the defect and dielectric band-edge modes, in accordance with examples of the present disclosure;

FIG. 19 is an illustration of four types of unit cells of photonic crystal rings (PhCRs), in accordance with examples of the present disclosure;

FIGS. 20A and 20B are scanning electronic microscope (SEM) images of a rod photonic crystal ring (rPhCR), in accordance with examples of the present disclosure;

FIG. 21 is an illustration of a finite-element-method simulation of a unit cell of the rPhCR, in accordance with examples of the present disclosure;

FIGS. 22A-22D are an illustration of transmission spectrums of the rPhCR, in accordance with examples of the present disclosure;

FIGS. 23A-23E are infrared images of the five band-edge modes, in accordance with examples of the present disclosure;

FIG. 24 is an SEM image of cells in the uniform region and defect region of an rPhCR, in accordance with examples of the present disclosure;

FIG. 25 is an illustration of a defect photonic crystal cavity mode simulation, in accordance with examples of the present disclosure;

FIGS. 26A-26D are an illustration of transmission spectrums of the defect rPhCR, in accordance with examples of the present disclosure;

FIGS. 27A-27E are infrared images of the five band-edge modes of the rPhCR, in accordance with examples of the present disclosure;

FIG. 28 is an SEM image of a slit photonic crystal ring (sPhCR), in accordance with examples of the present disclosure;

FIG. 29 is an illustration of a finite-element-method simulation of a unit cell of the sPhCR, in accordance with examples of the present disclosure;

FIG. 30 is an illustration of a transmission spectrum of the sPhCR, in accordance with examples of the present disclosure;

FIGS. 31A-31D are an illustration of transmission spectrums of the sPhCR at the TE1 mode of FIG. 30, in accordance with examples of the present disclosure;

FIGS. 32A-32D are an illustration of transmission spectrums of the sPhCR at the TE2 mode of FIG. 30, in accordance with examples of the present disclosure;

FIG. 33 is a graph illustrating the bandgap width of a photonic crystal structure over a modulation ratio, in accordance with examples of the present disclosure;

FIG. 34 is a set of graphs illustrating the bandgap width of a photonic crystal structure with a range of modulations, in accordance with examples of the present disclosure;

FIG. 35 is a diagram of a bandgap demonstrating the difference in frequencies between dielectric and air band-edge modes, in accordance with examples of the present disclosure;

FIG. 36 is a set of graphs illustrating the bandgap width of the PhCR structure with a range of modulations, in accordance with examples of the present disclosure;

FIG. 37 is a graph illustrating cavity transmission of the dielectric and air band-edge frequencies of the photonic crystal ring, in accordance with examples of the present disclosure;

FIG. 38 is a graph illustrating the frequency offsets of the dielectric and air band-edge modes over frequency differences of the PhCR, in accordance with examples of the present disclosure;

FIG. 39 is a graph illustrating a band-closing device containing both dielectric and air band-edge modes, in accordance with examples of the present disclosure;

FIGS. 40A-40C are a set of diagrams illustrating the dominant electric field of the dielectric and air band-edge modes in devices with three modulation amplitudes, in accordance with examples of the present disclosure;

FIGS. 41-46 are graphs illustrating band flipping and bandgap closing behavior given a change in frequency of dielectric band modes and air band modes in a silicon nitride core and the resulting change in wavelength in a silicon dioxide substrate, in accordance with examples of the present disclosure; and

FIGS. 47-49 are a set of diagrams illustrating distributed feedback laser output at a bandgap closing point, in accordance with examples of the present disclosure.

### DETAILED DESCRIPTION

The present disclosure relates generally to the field of on-chip optical parametric oscillation (“OPO”) and laser injection locking. More specifically, the present disclosure provides systems and methods for generating a coherent laser light.

Although the present disclosure will be described in terms of specific examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

OPO is distinguished by its wavelength access, that is, the ability to flexibly generate coherent light at wavelengths that are dramatically different from the pump laser (e.g., input laser) and, in principle, bounded solely by energy conservation between the input pump field and the output signal (e.g., idler) fields. The disclosed microring resonator 130 provides the benefit of both improving laser coherence and enabling the changing of the laser signal's wavelength in the same photonic crystal microring.

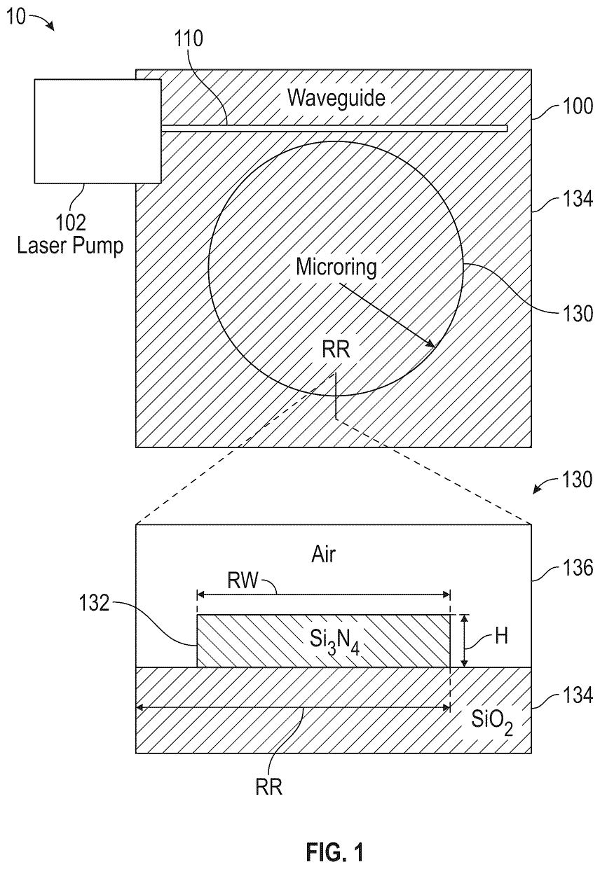

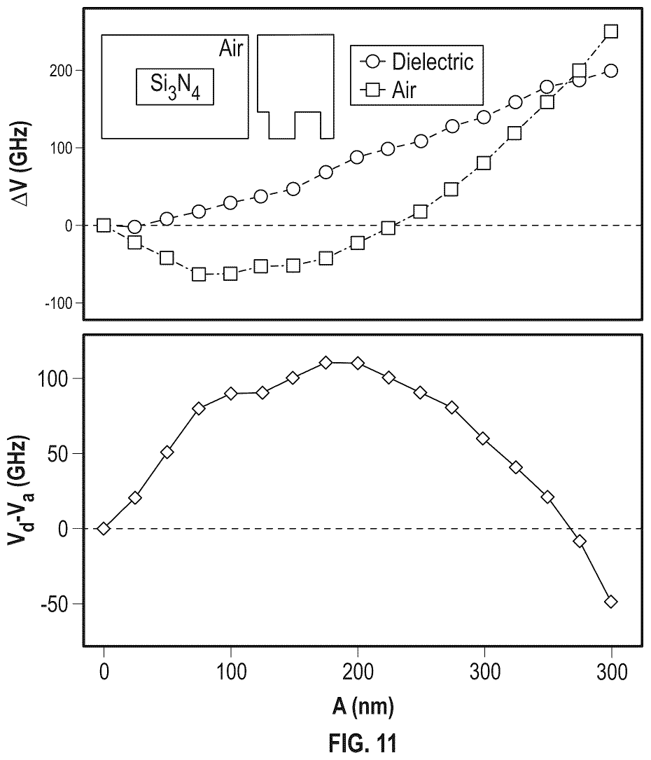

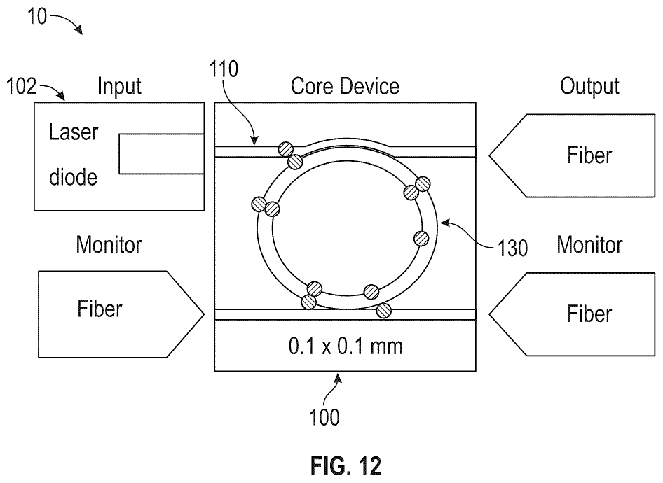

Referring to FIGS. 1-5 and 12, diagrams of an example system 10 and device 100 for generating a coherent laser light using OPO, are shown. The device 100 is configured for on-chip coherent light generation and compact self injection locking. The term conpact as used herein includes sub 100×100 micrometer devices. The device 100 provides the benefit of enabling broad spectral coverage with small device footprints at a low pump power.

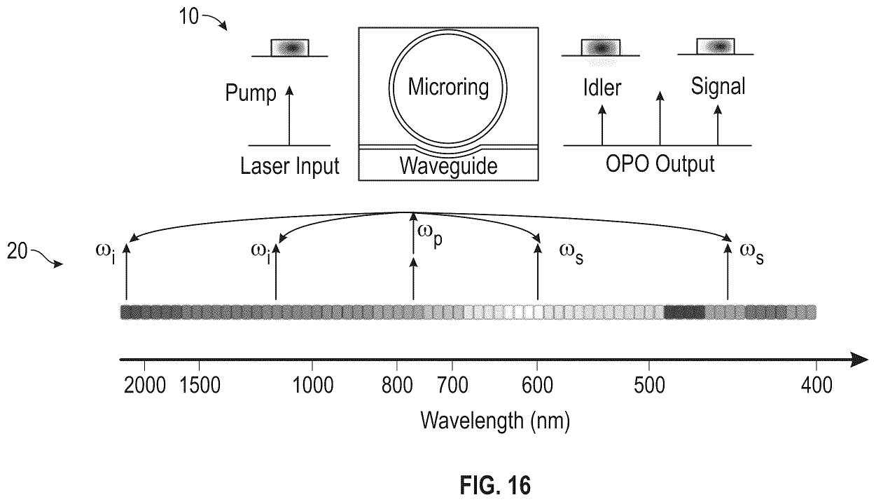

The system 10 may include a light source 102 (e.g., pump) configured to pump a first color laser light and a device 100 configured to generate a coherent second color light (i.e., signal) and a coherent third color light (i.e., idler) (FIG. 16). The device 100 generally includes a waveguide 110, and a microring resonator 130 (e.g., a microresonator) configured to generate a coherent second color light and the coherent second color light in response to the first color laser light. When the waves in the loop build up a round trip phase shift that equals an integer times 2π, the waves interfere constructively and the cavity is in resonance.

The microring resonator 130 may include a photonic crystal ring (PhCR). The microring resonator 130 may include a rod photonic crystal ring (rPhCR) or a slit photonic crystal ring (sPhCR). The microring resonator 130 enables access to an output frequency that is significantly different than that produced by the light source 102 (e.g., a Fabry-Perot laser chip). The microring resonator 130 is comprised of unit cells with shapes including, but not limited to, rods, slits, and microgears.

The coherent second color light is a different color than the first color laser light. The coherent third color light is a different color than the first color laser light. The coherent second color light is a different color than the third color laser light. The waveguide 110 is configured to couple the light source 102 to the microring resonator 130. The waveguide 110 may be comprised of, for example, silicon nitride and/or silicon oxynitride or other such suitable materials.

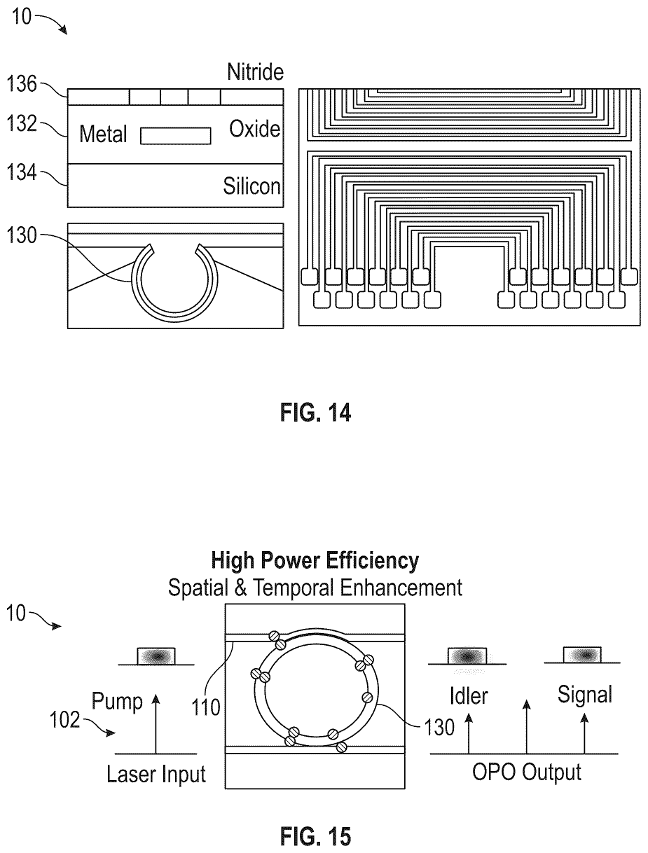

The microring resonator 130 generally includes a layer 132 comprised of silicon nitride (Si₃N₄) and a substrate 134 comprised of silicon dioxide (SiO₂). It is contemplated that other suitable materials may be used for the substrate 134 and for the layer 132. For example, the layer 132 material may include sapphire, quartz, MgF₂, or any material with a similar refractive index. The layer 132 may include rods. The layer 132 includes a ring width (RW) which can be configured for tuning the microring resonator 130, a ring radius (RR), and a height (H). The microring resonator 130 may include a cladding 136 comprised of air. The cladding 136 may be disposed on a first side of the layer 132. The microring resonator 130 includes a plurality of modes selected from different families of modes. The modes are typically either transverse-electric-like (TE) or transverse-magnetic-like (TM). In aspects, the microring resonator 130 may further include a layer of silicon (Si) disposed on a second side of the substrate 134. The microring resonator 130 may further include a heater 139 configured for thermal management of the microring resonator 130. Other material stack-ups are contemplated (FIG. 14). In aspects, the microring resonator 130 and the waveguide 110 may be either on the same layer or on different layers of a common substrate 134.

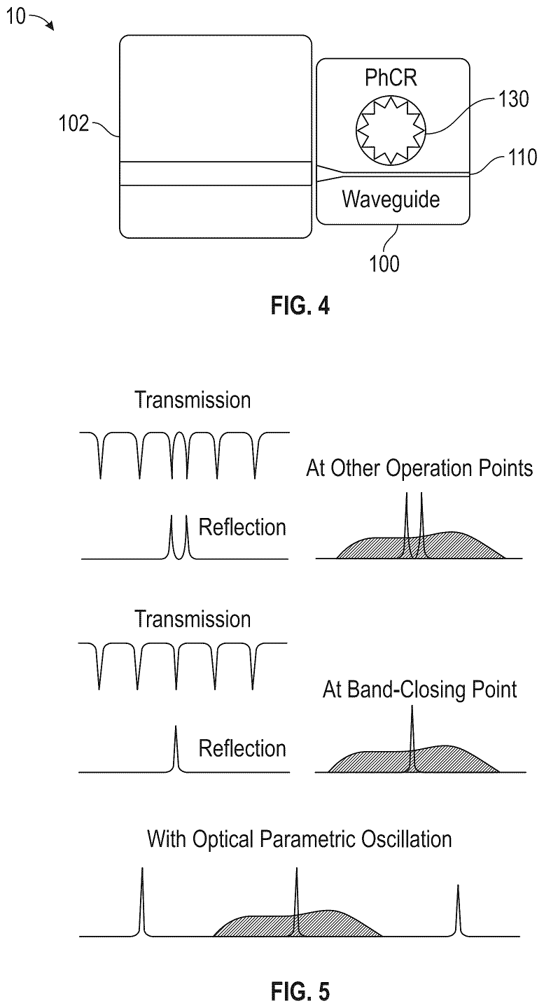

The system 10 includes a compact microring device scheme for injection locking of a chip integrated laser and optical parametric oscillation, and achieves four functionalities at the same time all within the footprint of microring resonator 130: (1) providing a narrowband filter due to high optical quality whispering gallery mode (WGM), with a compact footprint in an integrated photonics platform; (2) providing reflection of the narrowband filtered signal determined by targeted mode numbers (and hence frequencies) within the microring, while other (untargeted) modes remain traveling waves, so that no external reflector/coupling design is needed; (3) single frequency reflection is possible, without the need of external filtering or dual-ring configuration, which is based on band flipping and bandgap closing in photonic crystal microring devices (FIG. 5); (4) this scheme can be combined with optical parametric oscillation in the same ring (FIGS. 4 and 5), which can extend the output frequency far beyond the gain spectrum of the pump laser that is injection locked. Some example uses of the system 10 include: (1-2) compact injection locking only; (1-3) single-frequency injection-locked lasing; (1-2, 4) injection-locked lasing and optical parametric oscillation; or (1-4) single-frequency injection locked lasing (e.g., self injection locking) and optical parametric oscillation, depending on the application needs. All these applications (1-4 and combinationtions thereof) may be performed within the footprint of the microring resonator 130.

Existing technology has the following issues: the footprint of injection-locking photonic chips is often large, which may incur more cost, instability in operation, and complication in fabrication. Injection-locked lasing requires extra components for reflection, for example, external looped back coupling waveguides. These external components typically have broadband response, not as narrowband as the microring, so they will incur reflection at many frequencies and thus require extra efforts in the filtering of other frequencies. Injection-locked lasing also requires extra components for filtering, for example, dual-ring configuration or external cavity filtering. These extra components, though providing extra tunability, typically need electrical-optical or thermal-optical control and thus increase device footprint, power budget, and design/fabrication steps. The injection locking is limited to the gain spectrum of the pump laser that is injected into. If using a separate OPO device, the OPO device needs to be tuned to the injection locking device, which further complicates the device operation, decreases the stability, and increases the footprints. The disclosed technology provides the benefit of solving these issues.

In on-chip injection locking, a high-quality factor (Q) microring resonator 130 may be used to provide a narrowband filtered signal (i). To reflect this filtered signal as feedback for the input laser, an external reflection component, for example, a loop-back waveguide and coupler is needed (ii). If the cavity free-spectral range is narrower than the gain spectrum, a mode selection method, for example, dual-ring filtering, may be needed (iii). Because the microring mode is a traveling wave without an inscribed geometric phase, phase tuning may be needed for injection locking (iv).

The system 10 provides reflection, mode selection, and geometric-locked phase automatically (i). In particular, at the bandgap closing point, the device can provide a single-frequency reflection signal (ii). This compact injection locking scheme is compatible with optical parametric oscillation (iii), which can further extend the lasing wavelengths beyond the laser chip gain spectrum.

The system 10 enables accurate frequency control, for example, in applications such as the dispersion engineering of nonlinear optics, including frequency comb and optical parametric oscillation. Of particular usefulness is the single-frequency mode at the bandgap closing point for the lasing applications. These two degenerate modes offer reflection signal from the microring to the waveguide, without creating mode splitting and, therefore, dual-frequency competition.

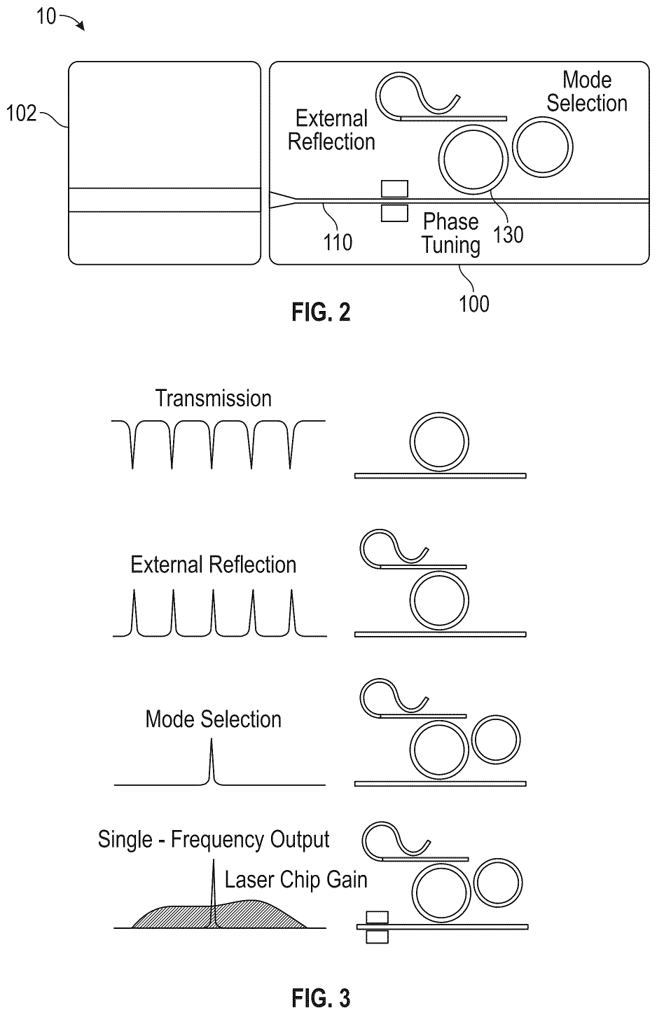

Injection locking is a method to turn a multi-mode laser with a broad and noisy frequency spectrum (for example, a Fabry-Perot laser) to a single-mode laser with a single clean frequency. Injection locking typically requires high-quality-factor cavity, external reflection component, single mode selection or filtering, and phase control of the reflection signal, as illustrated in FIG. 2. These components, while providing individual control functionality, require many designing and fabrication processes. Using a PhCR instead of conventional microring can provide ultra-compact injection locking (FIG. 4). Four functionalities, including high-quality-factor cavity, reflection, mode selection, and geometric-locked phase, may be achieved at the same time in the PhCR, at the price of creating dual-mode competition problem, similar to that in a distributed-feedback laser. In particular, at (or around) the band-closing point, single-frequency injection locking can be achieved in a single PhCR FIG. 5. The compactness of this injection locking scheme reduces the fabrication cost and may increase the operation stability, as all functionalities are integrated into one device. The simplification of the device scheme makes it more compatible with optical parametric oscillation, which can occur in the same PhCR device, as illustrated in FIG. 5.

For distributed-feedback lasing, dual-mode competition is a big issue in laser manufacturing that reduces the yield. This dual-mode competition is attributed to the random phase created by the cleaved facet. While putting a phase slip with the correct size and placement can discriminate mode in the distributed grating, many manufacturers nowadays are still designing uniform grating and discarding the lasers with the dual-mode competition. Photolithography technology can be used to create such grating structures, though the geometric offset from the pattern perhaps needs more calibration than electron beam lithography used in this work.

The present disclosure demonstrates the use of low-pressure chemical vapor deposition, with a nominal thickness of 600 nm on a 3 μm thick SiO₂ layer, to grow the stoichiometric Si₃N₄ layer. The growth is performed through thermal wet oxidation of a 100 mm diameter Si wafer. To re-assure the Si₃N₄ layer thicknesses and its wavelength-dependent refractive index, spectroscopic ellipsometry may be used to fit the index to an extended Sellmeier model. On top of the Si₃N₄ layer, a layer of positive-tone resist (approximately 650 nm thick) is spun, which is exposed by a 100 keV electron-beam lithography system. The device layout is put together by using the Nanolithography Toolbox. Following this preparation, CHF₃/O₂ chemistry is used to etch the Si₃N₄, transferring the layout from the resist. This reactive ion etching process has a rate of approximately 30 nm per minute. The remnant resist material and deposited polymer during etching is later chemically cleaned. In aspects, a SiO₂ lift-off process creates a top air cladding for the microring resonators and a top SiO₂ cladding for the input/output edge-coupler waveguides. Such top and bottom SiO₂claddings have their own advantages, including generating more symmetric modes for coupling to optical fibers and lowering the fiber-chip facet coupling loss to about 2 dB to about 3 dB per facet. The oxide lift-off process relies on photolithography, plasma-enhanced chemical vapor deposition of SiO₂ with an inductively-coupled plasma source, and the chemical removal of the photoresist. Following the lift-off, the chips are later diced and polished, and annealed at about 1000 degrees Celsius in an N₂ environment for 4 hours. To observe the complete closing of the bandgap, the device resonance is tuned by wet etching selective to silicon dioxide (potassium hydroxide with about 45% concentration heated to about 70 degrees Celsius).

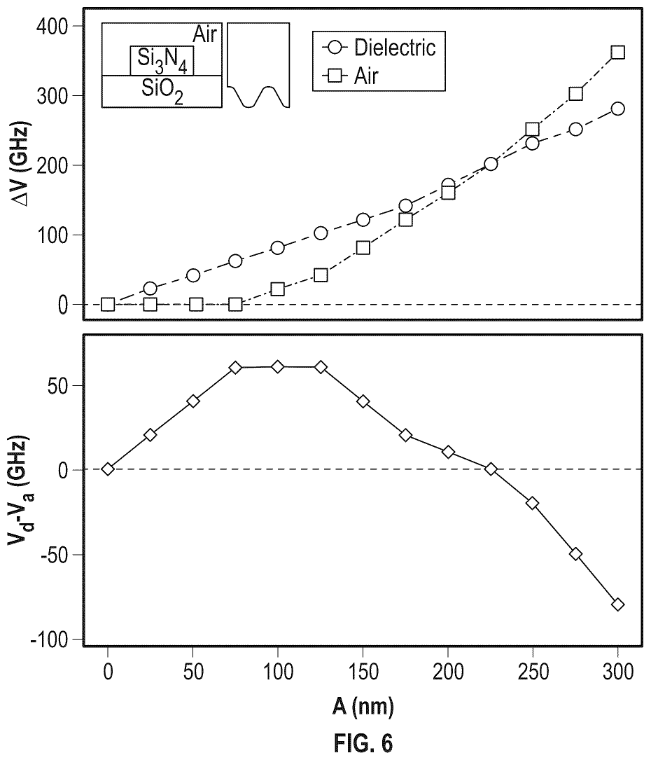

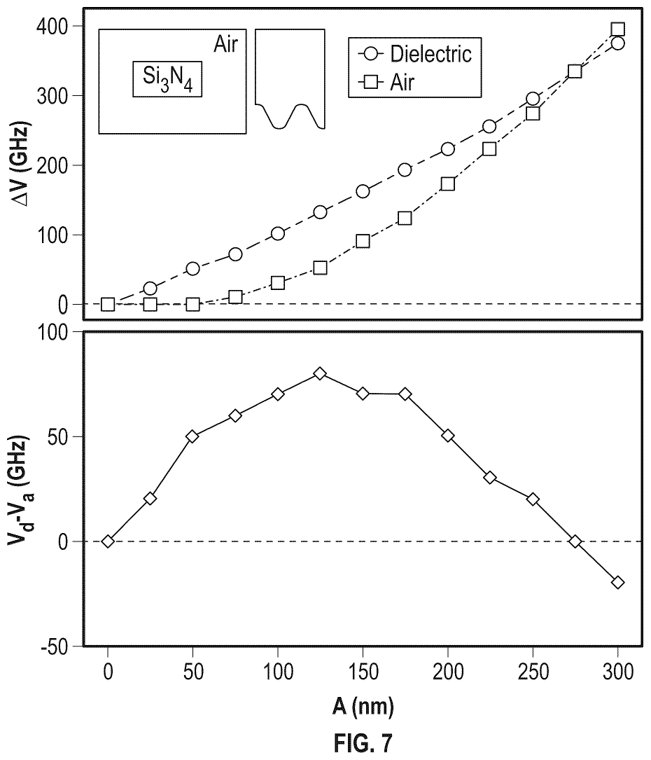

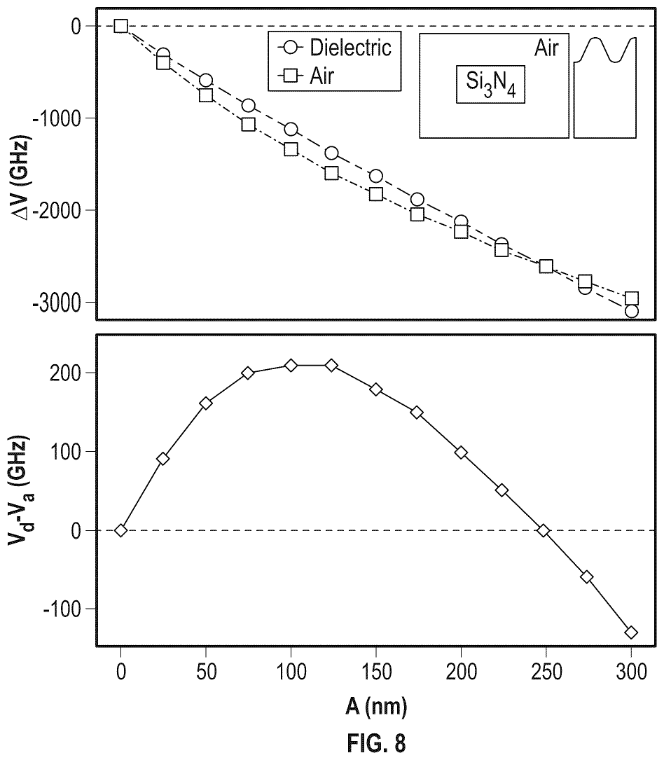

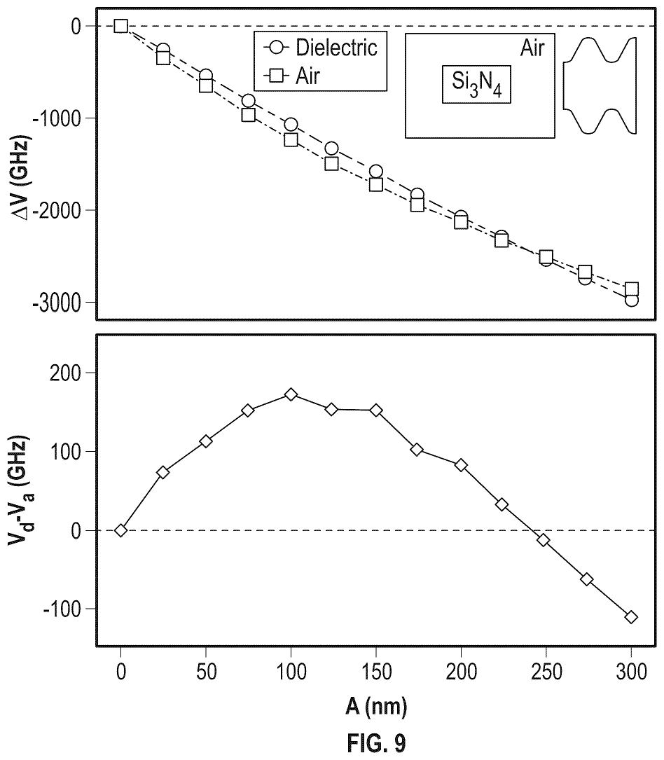

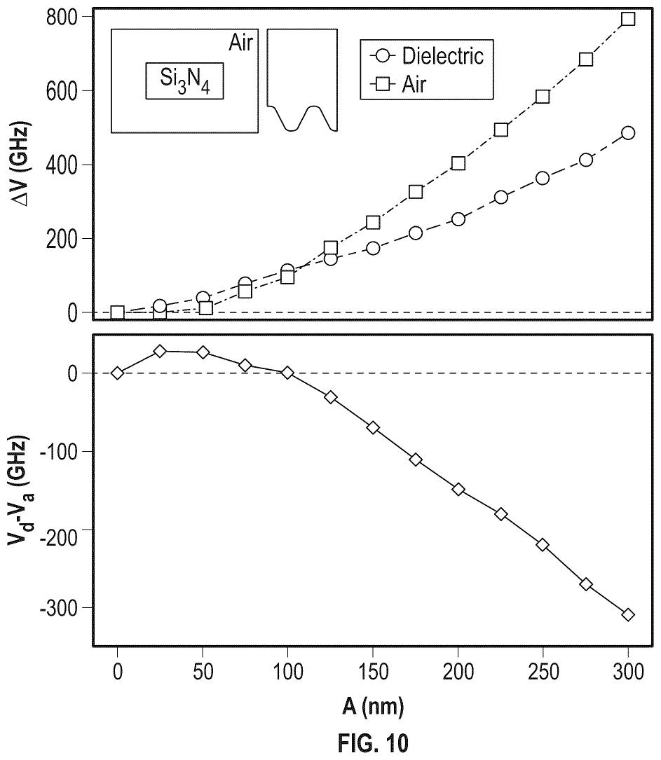

Referring to FIGS. 6-11, the graphs illustrate band flipping and bandgap closing behavior. The left inset shows the cross-section view of the silicon nitride (Si₃N₄) core with top air cladding and bottom silicon dioxide (SiO₂) substrate. The right inset shows the top view of the 1.5-unit cell of the photonic crystal ring, with the inside ring radius modulated in a sinusoidal profile.

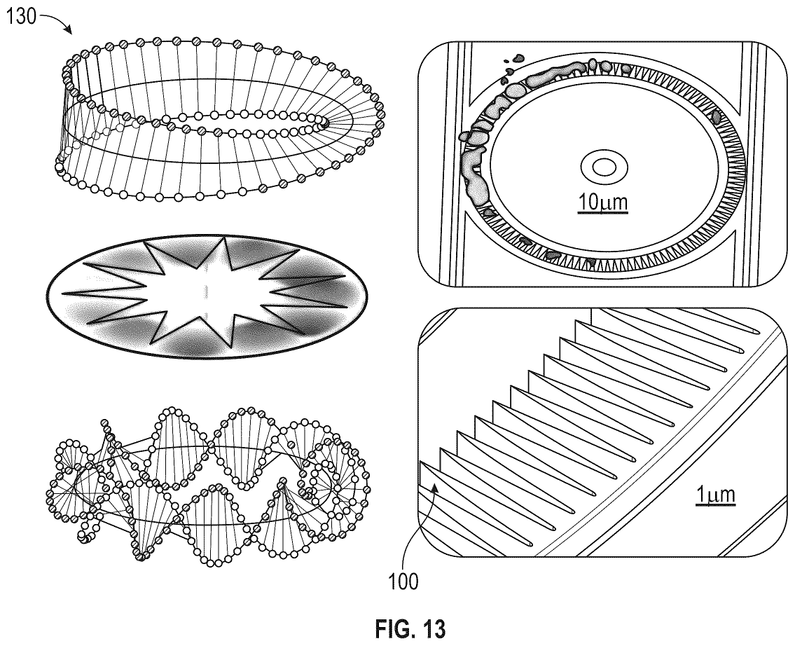

The PhCR designs may include rod and slit unit cells (FIG. 13), whose geometries are more suitable for solid-state cQED. Both rod and slit PhCRs have high-Q (e.g., greater than about 10⁶) with WGM coupling properties preserved. A further about 10× reduction of V by defect localization is observed in rod PhCRs. Moreover, both fundamental and 2nd-order PhC modes coexist in slit PhCRs with high Qs and good coupling. The present disclosure showcases that high-Q/V PhCRs are, in general, straightforward to design and fabricate and are a promising platform to explore for cQED.

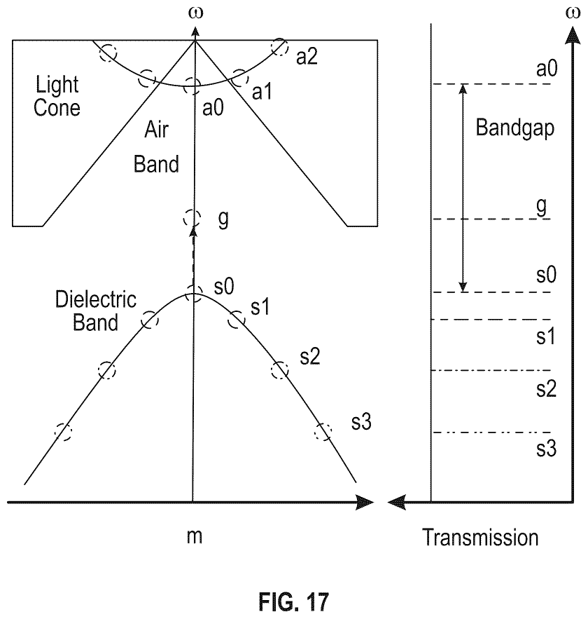

In reference to FIG. 17, a band diagram for a PhCR for cQED is shown. Air band modes are pushed up in frequency towards the light cone, and only those below the light cone are observed in waveguide-coupled transmission measurements. Dielectric band modes are compressed in free spectral range (the frequency separation between adjacent modes) around the band edge. The frequency difference of the air and dielectric band-edge modes a0 and s0 is the bandgap. Through defect localization, a defect mode g can be created from s0, with its frequency pushed into the bandgap. These mode characteristics can be observed in cavity transmission spectroscopy if the modes are properly waveguide-coupled.

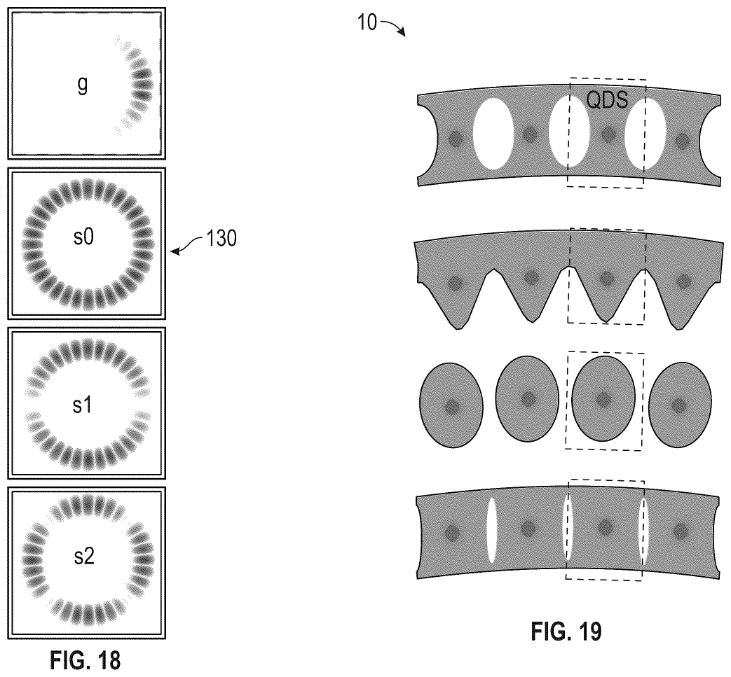

In reference to FIG. 18, an illustration of the spatial electric field profiles of the defect and dielectric band-edge modes is shown. All these modes are a redistribution in azimuthal angle, with similar mode profiles in a unit cell.

Referring to FIG. 19, two example types of PhCR designs with rod and slit unit cells whose geometries are similar to traditional PhC unit cells are shown. These designs also enable greater space between etched surfaces and potential integrated quantum emitters. For example, working in the silicon nitride platform, both rod and slit PhCRs have band-edge WGMs with Q greater than about 10⁶, and waveguide coupling properties are preserved in comparison to standard WGMs. A further about 10 times reduction of V by defect localization is observed experimentally in rod PhCRs. Moreover, both fundamental and 2nd-order PhC band-edge modes coexist in slit PhCRs with high Qs and good coupling at the same time. High-Q/V PhCRs in various geometries is straightforward to design and fabricate and highlight the platform's promise for applications in quantum optics. In particular, in the context of quantum optics with single quantum emitters (including cQED), defects in 2D materials, single organic molecules, and colloidal quantum dots have all been integrated with silicon nitride photonics. The PhCR approach can be translated to other single quantum emitter platforms by adapting designs for those materials or through heterogeneous integration.

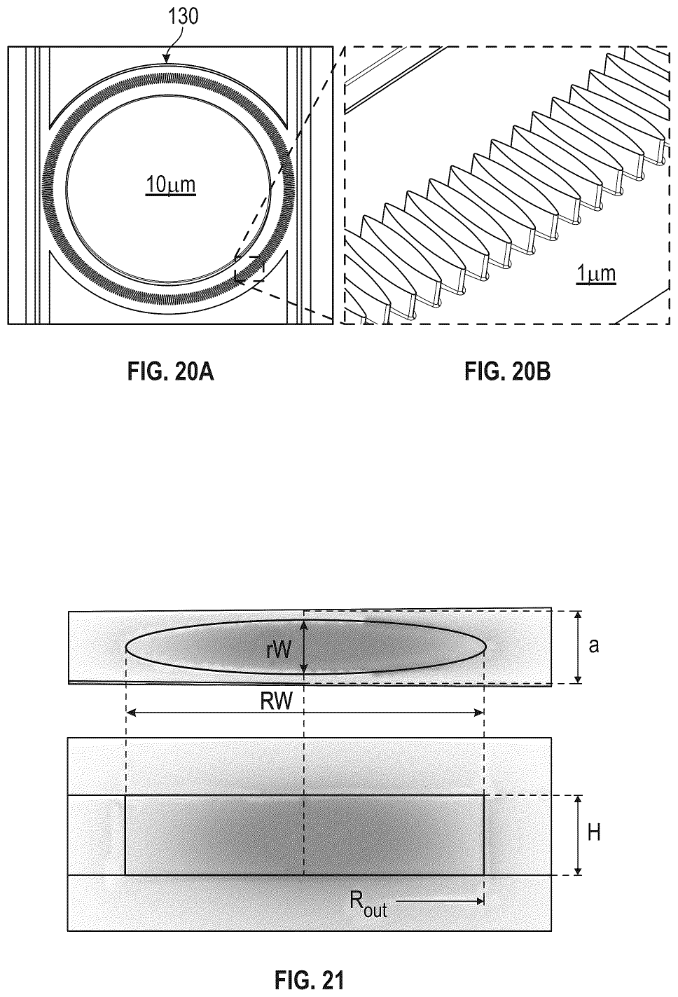

In reference to FIGS. 20A and 20B, a series of scanning electron microscope (SEM) images of the rod photonic crystal ring (rPhCR) device and a zoomed-in view of several units' cells of the rod structure are shown. The silicon nitride rods sit on top of a silicon dioxide substrate with top air cladding. For the rods, other materials may be used that have a higher refractive index than the substrate.

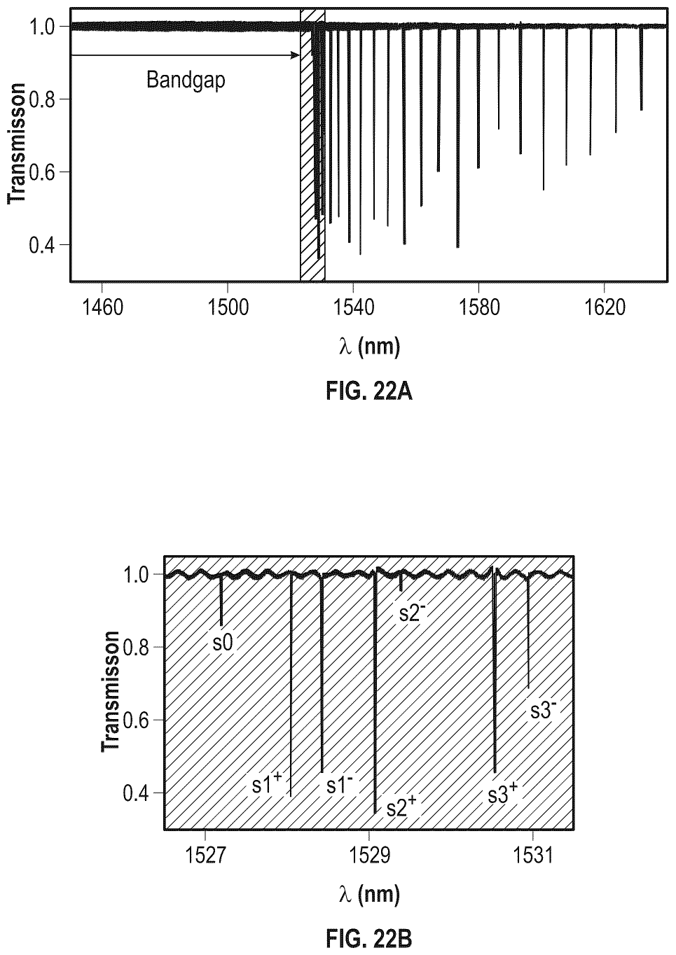

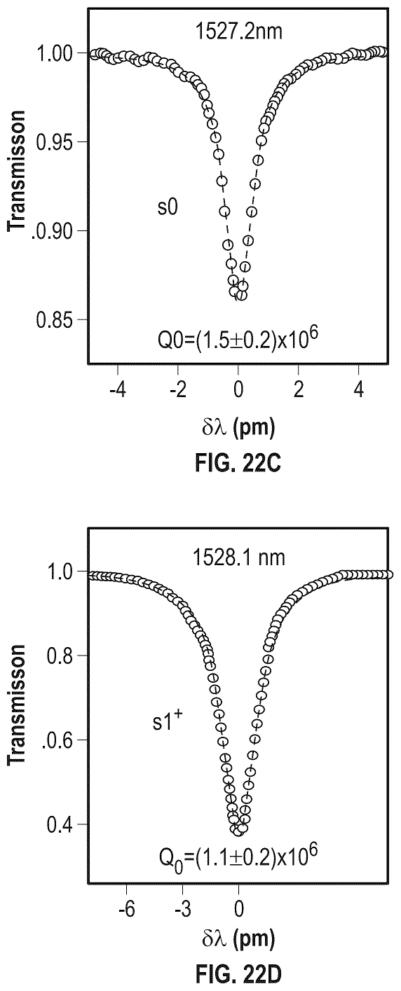

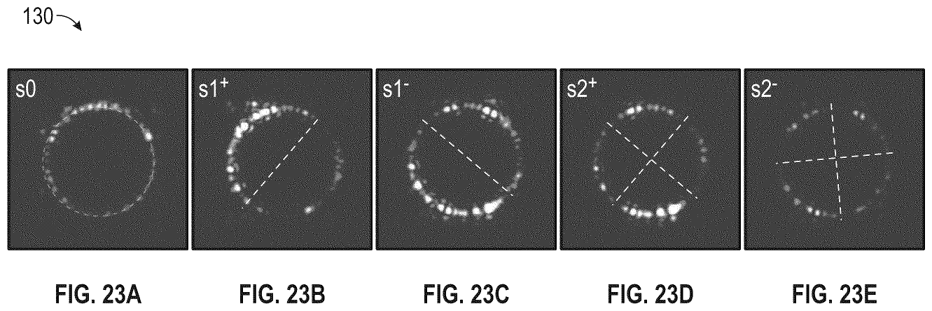

Referring to FIGS. 20A and 20B, an SEM image with the rPhCR with two coupling waveguides is shown. The outer radius of the microring (Rₒᵤₜ) is 25 μm, containing 324 identical unit cells, with adjacent cells spaced by a=460 nm. Only the right waveguide is used in the measurements, with a ring-waveguide gap of approximately 650 nm. The zoomed-in image shows about 15 cells (FIG. 21), with each cell having an elliptical shape whose major and minor axis lengths are RW=2.25 μm and rW=354 nm, respectively. A finite-element-method simulation of a unit cell is executed to find the fundamental transverse-electric-like (TE1) mode, s0, at approximately 196.3 THz, using refractive indices of 1.98 for the silicon nitride core and 1.44 for the silicon dioxide substrate. The dominant electric field of the fundamental transverse electric polarized mode (TE1) is in the radial direction, with an amplitude plotted in FIG. 21 with a top view (the top panel) and cross-sectional view (the bottom panel). The modes are well confined in this rod structure and almost centered in the cell, even though the bending effect associated with the ring's radius of curvature is considered. As schematically illustrated in FIG. 17, the simulated s0 mode lies at the dielectric band edge and can be measured by cavity transmission spectroscopy. Referring to FIGS. 22A-22C, a large bandgap created in the spectrum is shown, with no resonances observed between 1450 nm (the lower end of the wavelength scan range) and 1527 nm. The s0 mode is observed at 1527.2 nm (196.4 THz), and many other band-edge modes (identified by their reduced mode spacing relative to conventional WGMs far from the band-edge) are well coupled. A zoom-in of the band-edge modes (shaded in pale red and shown in the central panel of FIGS. 22A-22C) shows seven modes. These modes, in general, have high Qs around or above 10₆, with the s0 and s1+ zoomed-in spectra shown in the rightmost two panels of FIGS. 22A-22C. Infrared images (FIGS. 23A-23E) are taken with the focus plane at the microring surface and confirm the spatial patterns of these slow light modes around the circumference of the PhCR. The s0 mode slightly deviates from a uniform pattern, likely due to randomness in scattering. The s1 and s2 modes agree with the theoretical prediction of |cos(φ)| and |cos(2φ)| intensity pattern (φ is the azimuthal angle), as illustrated in FIG. 18. Similar behavior has been observed for the MPhCR system.

In reference to FIG. 21, the results of a finite-element-method simulation of a unit cell of the rPhCR device are shown, displaying the dominant (radial-direction) electric field profile in top and cross-section views. The cell is 1/324 of the rPhCR circumference, with a cell width of a=460 nm and a thickness of H=500 nm. The elliptical rod has a major axis length of RW=2.25 μm and a minor axis length of rW=354 nm, and its outer ring radius is Rₒᵤₜ=24.875 μm. The simulated resonance frequency for the dielectric band-edge mode (s0) is 196.3 THz.

In reference to FIGS. 22A-22D, the transmission spectrum of the rPhCR device is shown, which has the same parameters in design as used in the simulation, except a rod width of rW about 414 nm in the designed pattern. This rW typically has an offset of approximately 60 nm after fabrication. The modes at the dielectric band edge (red area) are displayed in the middle panel, with the modes labeled as {s0, s1±, s2±, s3±}, where the labels follow FIG. 17, and the plus and minus signs indicate a higher and lower frequency, respectively. The two right panels show optical fitting to the s0 and s1+ modes, respectively, with optical intrinsic quality (Q0) above 10⁶. The uncertainties of the Q0 values specified here represent the 95% confidence interval of the nonlinear least squares fitting.

In reference to FIGS. 23A-23E, infrared images of the five band-edge modes {s0, s1±, s2±} are shown.

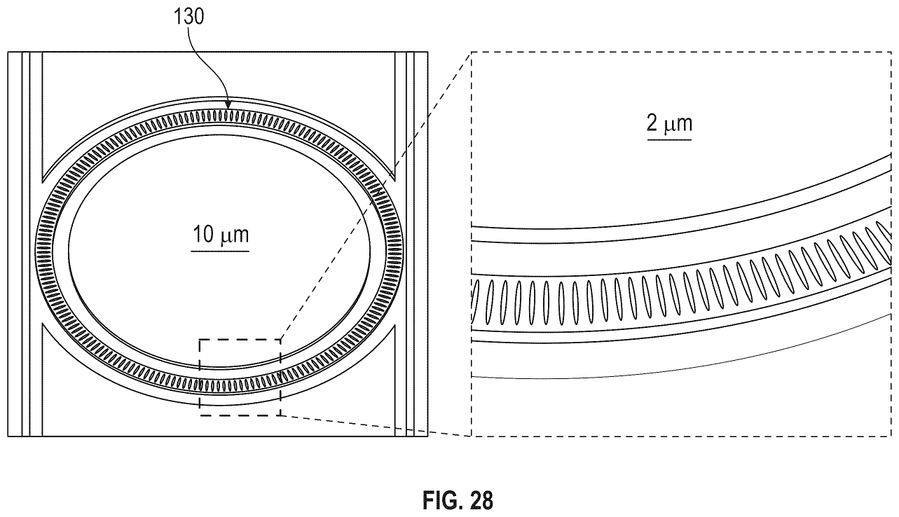

The rPhCR device geometry resembles a coupled-resonator optical waveguide, also termed a CROW, except that instead of a linear chain, the rod lattice is wrapped into a circular microring (FIG. 28). While the elliptical shape caters to WGMs better than the circular shape here, it is interesting to investigate the limitation of a circular rod PhCR, perhaps with a thicker film. The greater degree of symmetry of a circular rod unit cell can enable additional topological functionalities, particularly with respect to intersecting geometries.

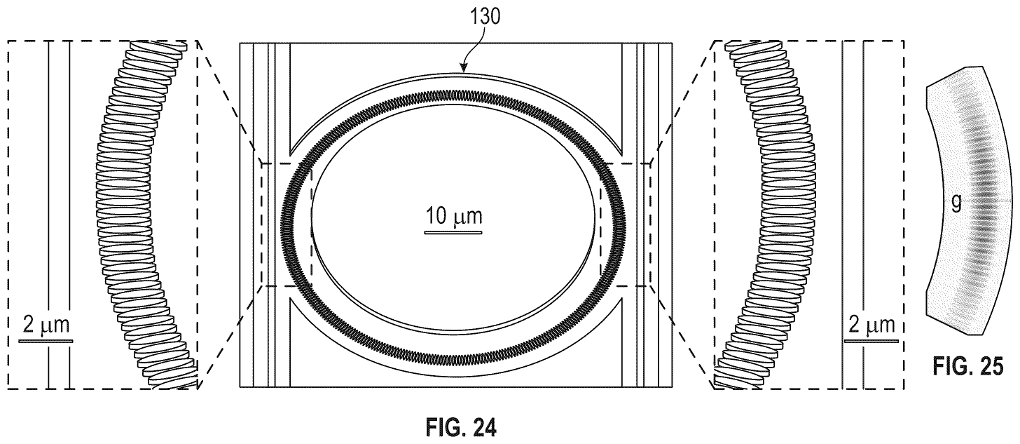

In reference to FIG. 24, a series of SEM images of a rPhCR device with zoom-in views of cells in the uniform region (left) and the defect region (right) is shown. The unit cell parameters are similar to those in FIGS. 20-23, except that its outer ring radius is now Rₒᵤₜ=25 μm. In the defect region, a scaling of the unit cell is introduced with a quadratic function across 48 cells and a maximal 15% reduction of the RW when it is closest to the waveguide. The center of the rods remains fixed in distance to the rPhCR center.

In reference to FIG. 25, a simulation of the defect photonic crystal cavity mode, labeled as the g mode hereafter, is shown.

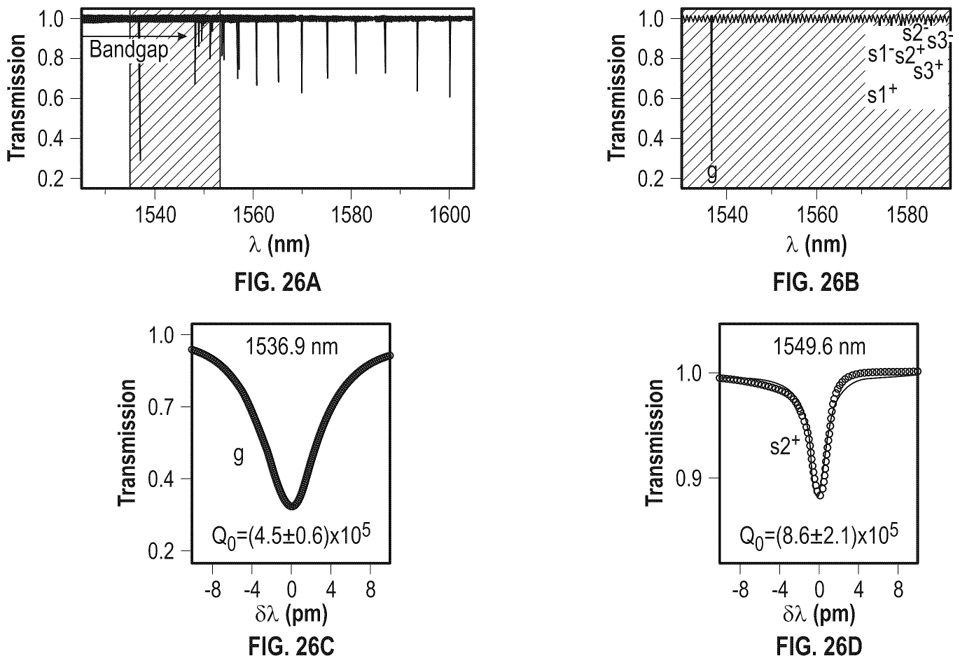

In reference to FIGS. 26A-26D, a transmission spectrum of this defect rPhCR device, showing the g mode, dielectric band-edge modes, and the bandgap (which extends as far as the non-defect devices in FIGS. 20-23 beyond the laser scan range) is shown. A zoom-in of the modes at the dielectric band-edge (pale red shaded area) is displayed in the middle panel, labeled as {g, s1±, s2±}. The right panels show nonlinear least squares fits to the g and s2+ modes, respectively. The g mode has a loaded optical quality of Qt=(2.4±0.1)×10⁵, with the intrinsic Q0 as displayed. The uncertainty of the Q values represents the 95% confidence range of the nonlinear fitting.

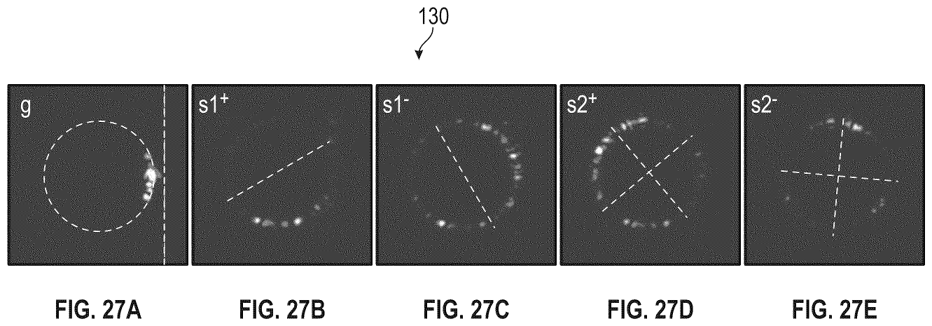

In reference to FIGS. 27A-27D, a series of infrared images of the {g, s1±, s2±} modes. This g mode is a localization of the s0 mode in a defect-free rPhCR.

Defect localization was previously reported with intuitive design in MPhCRs, where the defect is created by variation of a unit cell parameter (the PhC ring width modulation amplitude) across a number of cells and leads to a localization of s0 mode to g mode. This is illustrated in FIGS. 17-19, where the frequency shift of the g mode from the band edge is determined by the depth and width of the ring width modulation comprising the defect.

In reference to FIG. 24, a moderately-confined defect to the right part of the rPhCR is shown. The defect is comprised of many cells (48 in the example shown here), with a quadratic variation in the rod linear dimensions (RW and rW), with the central defect cell linear dimensions being 85% of RW of an unperturbed unit cell. The center of the ‘rods’ remains fixed in distance to the rPhCR center. A portion of the rPhCR containing the defect region using the finite-element method (FEM) is simulated, with the g mode equating to approximately 198.1 THz.

FIG. 25 illustrates a mode profile, showing confinement within the modulated cells (e.g., rods).

FIGS. 26A-26D illustrate the device transmission spectrum. The device transmission spectrum shows the g mode is located around 1536.39 nm (195.2 THz). The deviation from the simulation is likely due to the deviation of the size of the defect cells from the targeted device pattern and in principle, can be calibrated if the geometry is characterized more accurately. The g mode is deep in the bandgap, while six other modes are compressed around the band edge. While the Q remains high (near 5×10⁵), the fit shows a decrease in Q0 by a factor of 3 for the g mode relative to the band-edge states of the rPhCR without defect, potentially due to parasitic loss associated with scattering induced by the access waveguide. The slow light modes have higher Q0 values as they are undercoupled and free from this parasitic loss. The infrared images of the s1 and s2 band-edge modes in FIGS. 27A-27D are similar to those of the rPhCR without defect (FIGS. 23A-23E). In contrast to s0 in FIGS. 23A-23E, the g mode in FIGS. 27A-27D shows a clear localization within the defect cells (approximately ⅛ of the ring in a dashed circle), with the central defect close to the waveguide (dashed vertical line) brightest.

The increase in modal confinement from s0 to g (>10×) can be further optimized by incorporating deeper modulation across a smaller number of cells. The rPhCR has more degree of freedoms in introducing the defect, in comparison to the MPhCR, as the boundary is no longer continuous. For example, the center of each rod can be shifted, and the orientation of each rod can be rotated. It is thus interesting to explore what combination of parameter modulation can lead to the highest Q/V in design and fabrication. Beyond cQED, the rod geometry can be advantageous in nonlinear optical interaction in its confined volume and ideal mode overlap. For example, the localized defect mode can be promising in achieving efficient second harmonic generation with fundamental mode in the defect rPhCR mode (g) and second harmonic mode in a single nanorod (FIG. 15).

In reference to FIG. 28, a series of SEM images of the slit photonic crystal ring (sPhCR) device and a zoomed-in view of the slit structure is shown. The sPhCR has an outer ring radius of 25 μm, a ring width of 2.5 μm, and a thickness of H equals about 500 nm. There are 332 identical cells in this sPhCR with a period of about 450 nm. Each cell has an elliptical air slit that is 2 μm long and s equals about 90 nm wide.

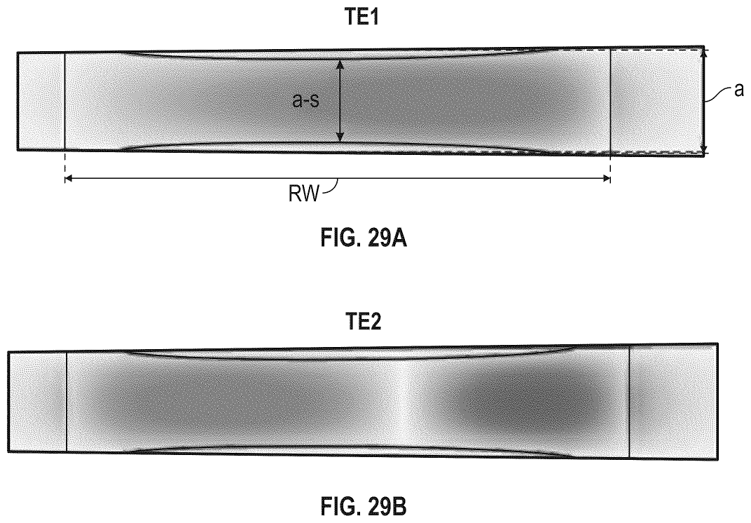

In reference to FIGS. 29A-29B, a finite-element-method simulation of a unit cell of the sPhCR device is shown, displaying the dominant (radial direction) electric field profiles of the fundamental and 2nd-order band-edge modes in top view, labeled as TE1 and TE2, respectively.

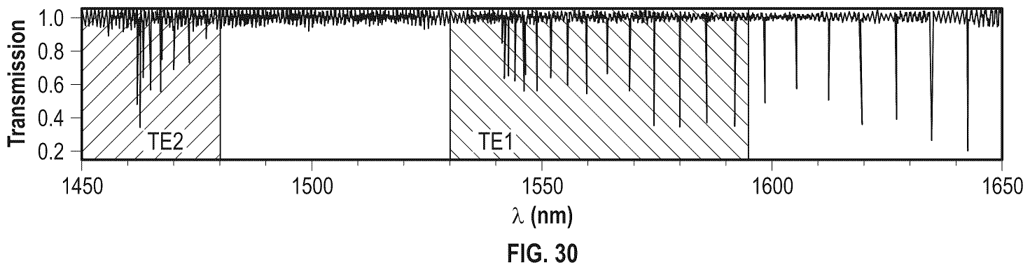

In reference to FIG. 30, a measured transmission spectrum of the sPhCR device showing two sets of dielectric band modes is shown.

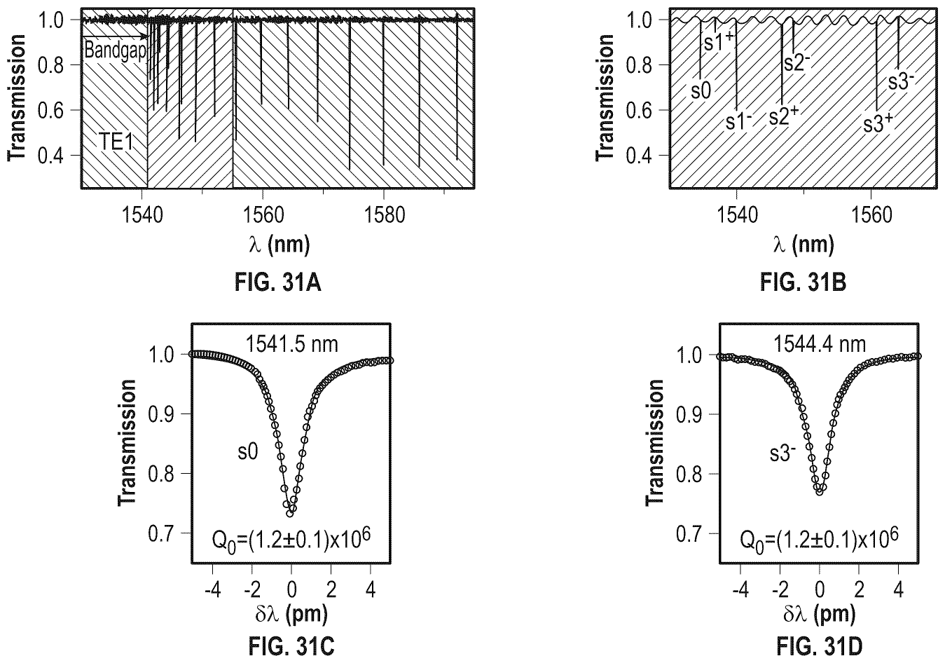

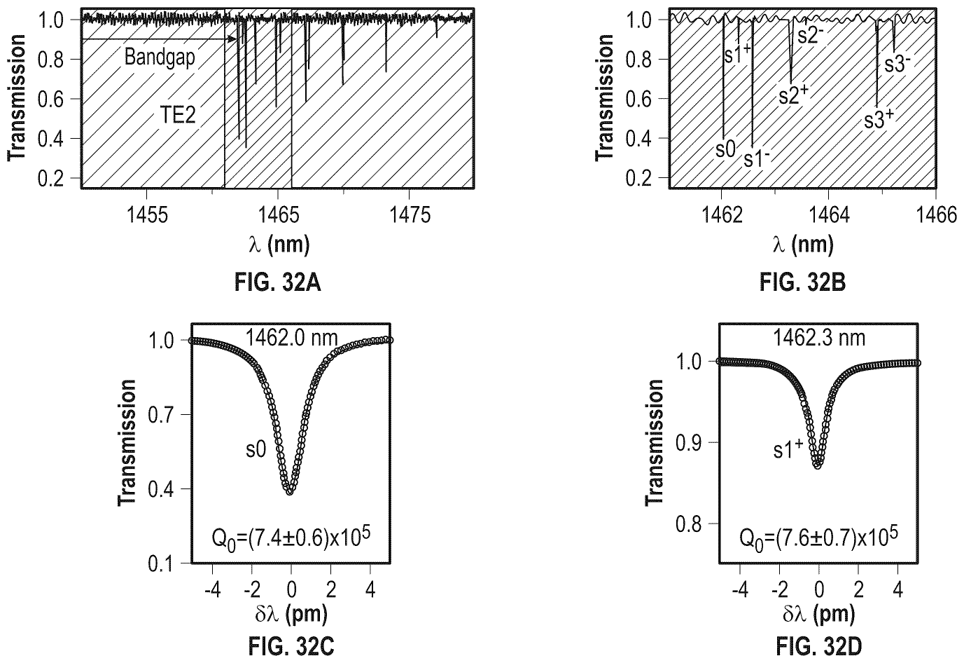

In reference to FIGS. 31A-31D and FIGS. 32A-32D, a series of modes are shown at the TE1 and the TE2 dielectric band-edge (pale red shaded areas) are zoomed-in and displayed in the middle panel, labeled as {s0, s1±, s2±, s3±}. The right panels show nonlinear least squares fits to the s0 and s3−/s1+modes, respectively. The uncertainty in Q0 represents the 95% confidence range of the nonlinear fits.

The success of the rPhCR with an elliptical unit cell, in contrast to the lower-Q circular-rod PhCR previously studied, seems to suggest that a design principle for a high-Q PhCR is to maximally cater (and minimally perturb) the conventional WGM mode shape. Following this principle, the aspect ratio of the air holes in previous PhCRs is reduced, forming a slit PhCR, or sPhCR. This operation is possible in PhCRs because only a bandgap along the propagation (azimuthal) direction is needed, in contrast to two-dimensional PhCRs, where a large enough air-filling fraction is needed to open a full bandgap for all propagation directions. In reference to FIG. 28, the sPhCR device is fabricated to show SEM images. These SEM images seem to indicate that the air slit is fully etched through the silicon nitride layer, but a full inspection (i.e., focused ion beam cut and SEM imaging) of its cross-section has not been performed. Finite-element-method simulation of a unit cell is executed using the parameters specified in the caption and finds two sets of band-edge modes for the fundamental (TE1) and 2nd-order (TE2) mode families at 192.4 THz and 203.6 THz, respectively. The mode profiles are shown in the top view, with TE2 having two colors (red and blue), indicating the field node that results in the electrical field pointing in different radial directions (inward and outward). In the experimental device transmission spectrum of FIG. 30, these two bands are clearly observed, with TE1 and TE2 band edges at 1541.5 nm (194.6 THz) and 1462.0 nm (205.2 THz), respectively. The close correspondence of the simulations and experiments suggests that the slits are (or close to) fully etched. The TE1 modes show Q0s above 10⁶ and are mostly well coupled, while the TE2 modes show lower Q0=0.7×10⁶, because of the TE2 mode's larger overlap with the etched sidewalls and potential roughness. The existence of two high-Q mode families with intuitive design may be useful in cQED. For example, it is possible to have defect localization in these two mode families simultaneously so that the TE2 defect mode can be used to AC Stark shift a quantum emitter into precise resonance with a TE1 defect wavelength. Through this method, high Q/V can be supported simultaneously for both modes, resulting in potentially fast and efficient spectral control of the relative tuning of the coupled dipole-cavity system.

The size of the bandgap in a photonic crystal ring is intuitively considered to grow monotonically as the modulation amplitude of the grating increases. The ‘dielectric’ band and ‘air’ band flip, along with the self-closing of the bandgap at the flipping point, when the modulation amplitude in a photonic crystal ring increases. When the bandgap is closed, ‘dielectric’ and ‘air’ band-edge modes, are degenerate in frequency. The bandgap is closed to within full-wave-half-maximum linewidths, with the optical quality of the modes remaining unperturbed at around 1 million. Such band flipping and bandgap closing phenomenon exist in various photonic crystal ring geometries, verified by finite-element-method simulation. The two stand-wave modes with a degenerate frequency are particularly promising for single-frequency lasing applications. There exists a need for an ultra-compact injection locking scheme that integrates high-quality-factor cavity, mode selection and filtering, single-frequency signal reflection, and optical parametric oscillation, all in one photonic crystal ring.

Grating is one kind of photonic crystal structure with periodical modulation in one dimension. The modulation can have various shapes, including square, triangular, and sinusoidal profiles, amongst others. In such a periodic grating, there often exist ‘dielectric’ and ‘air’ modes, two standing-wave modes with their maximum (sometimes referred to as antinodes) of the dominant electric field amplitude overlapping with the dielectric or the air part more. Since dielectric has a higher index than air, the ‘dielectric’ mode may typically accommodate larger wavelengths, that is, the ‘air’ mode has a higher frequency. However, a counter-intuitive bandgap closure has been observed in photonic wire Bragg grating, which is predicted to generally exist in various periodic grating structures.

This one-dimensional grating structure can be implemented into a microcavity, either a microdisk or a microring, for broad interest, including orbital angular momentum (OAM) emission, slow light, and defect localization, single-mode lasing, and spontaneous pulse formation. In the grating structure with small amplitudes (a few nanometers to several tens of nanometers), the physics of OAM emission, where light is ejected vertically by the grating, is recently cross-linked with that of ‘selective mode splitting’ (SMS), where light is reflected backward by the grating, that OAM emission can be understood in a microcavity quantitatively.

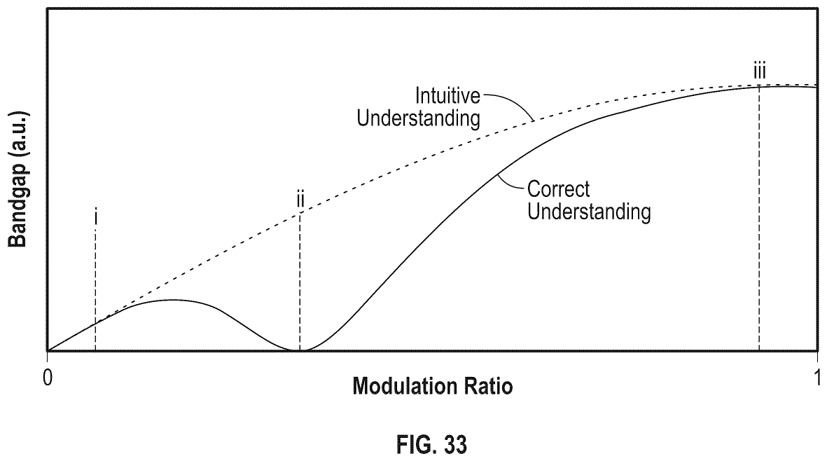

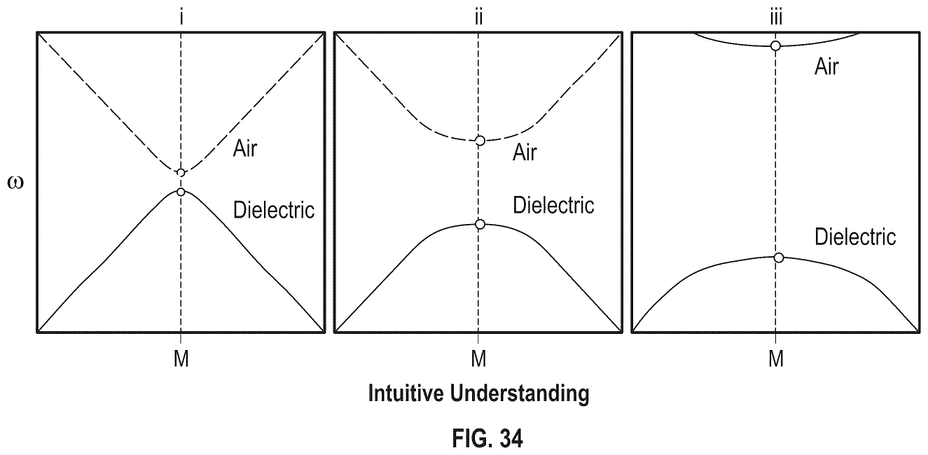

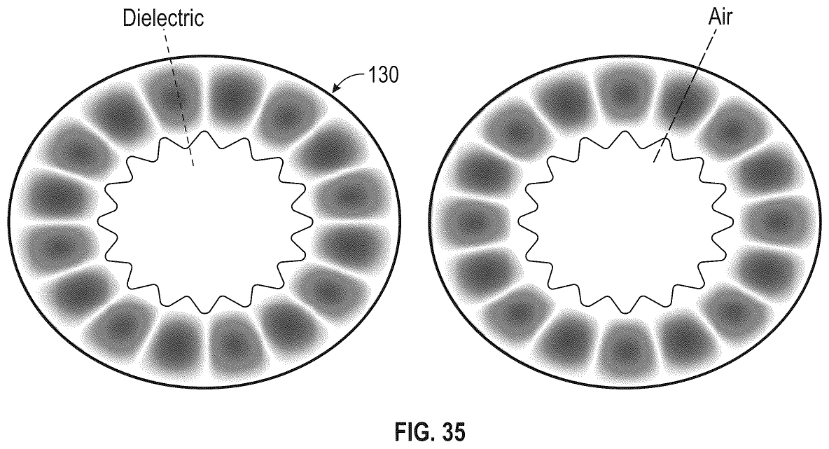

A perturbation theory for Maxwell's equations has been developed to calculate the change of resonance frequency of a given electromagnetic mode with shifting material boundaries. Following this theory, the calculated ‘air’ mode always has a higher frequency than the ‘dielectric’ mode, which seems quite natural based on existing knowledge of either one-dimensional grating discussed earlier or the PhCR results. This intuitive understanding of PhCR is illustrated by the yellow curve in FIG. 33. In reference to FIG. 35, the ‘air’ mode experiences a narrower ring width (and lower effective index) more, thus, a shorter resonance wavelength and higher frequency are displayed when compared to the ‘dielectric’ mode, which experiences a wider ring width. Based on such an intuition, the overall physics picture of a PhCR, from perturbative to non-perturbative regime, is a simple combination and extrapolation of these two regimes (FIG. 34).

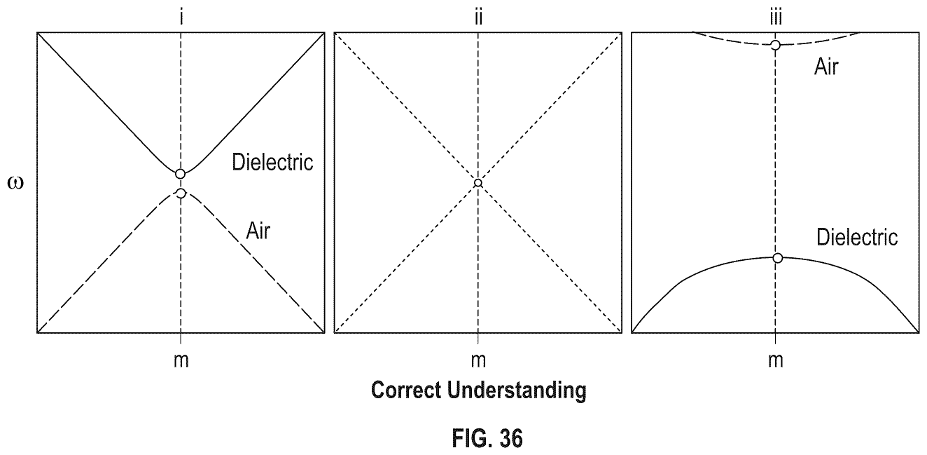

Referring to FIG. 36, an illustration of band flipping and bandgap closing in PhCRs is shown. In particular, the perturbation theory is not applicable on PhCRs with smaller modulations, and the ‘dielectric’ band and ‘air’ band should be flipped, as illustrated in FIG. 36. As a result, the band physics must be revised to the purple curve in FIG. 33, so that band flipping and bandgap closing are guaranteed (FIG. 36). Photonic band flipping is a phenomenon that occurs when the bandgap in a photonic crystal ring increases, closes, and then reopens. When the bandgap closes, a degenerate state is created. A transition to this state can be made through material and parametric choices. The transition to and across the degenerate point is a band flip.

In theory, the higher frequency band and lower frequency band will always depend on the energy confinement, that is, relatively, whether more located in the dielectric or more located in the air. However, such convention can not be used to consistently describe the PhCR band-edge modes throughout all modulation amplitudes.

Experimental measurements verify the band flipping and bandgap closing phenomenon. The experimental results are in close agreement with full 3-dimensional finite-element-method simulation in a unit photonic crystal cell. Simulations for various device geometries are displayed to show that the band flipping and bandgap closing behavior exists in various geometries regardless of symmetric or asymmetric cladding, inner or outer modulation, or different modulation shapes.

In particular, around the bandgap closing point, the device has two ‘dielectric’ and ‘air’ modes at almost degenerate frequencies, both with high optical qualities close to a million. In other words, the device can provide narrow-frequency back-scattering for incoming laser signals, which is particularly useful for lasing applications. The high optical quality factors also make the device suitable for efficient nonlinear optical processes. Along this line, an ultra-compact injection locking scheme is proposed, which can integrate high-quality-factor cavity, mode selection and filtering, single-frequency signal reflection, and optical parametric oscillation, all in the footprint of one single photonic crystal microring.

The present disclosure demonstrates band flipping and bandgap closing phenomenon in high-Q PhCR devices in silicon nitride nanophotonics platform. This platform has been successful in frequency comb, optical parametric oscillation, and injection locking. PhCR devices with small amplitudes (less than about 100 nm) in this platform have been used for frequency comb and optical parametric oscillation to provide additional dispersion engineering functionalities. PhCR devices with large amplitudes (a few hundred nanometers) have been studied for slow light and defect localization.

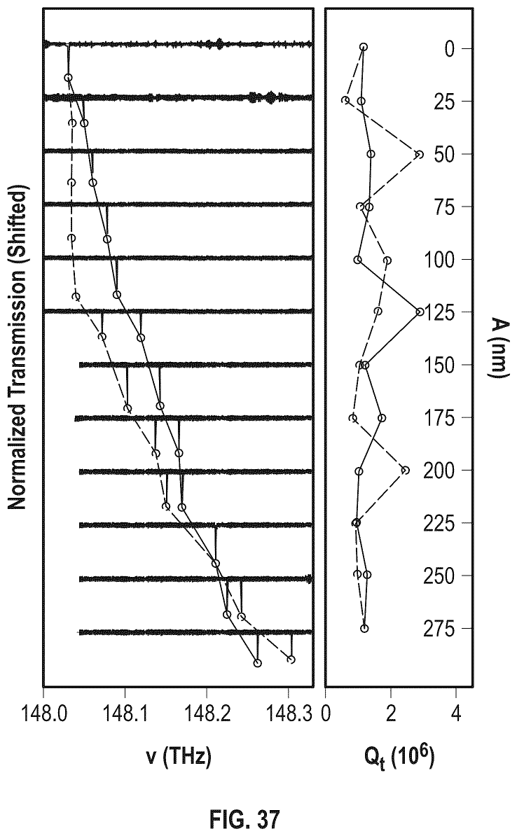

Referring to FIG. 37, graphs illustrating the band flipping and bandgap closing phenomenon in a set of PhCR devices are shown. Twelve PhCR devices are measured with the inside ring radius modulated in sinusoidal shape by different amplitudes (As). As is kept as a positive real number, as the additional phase term is not relevant to the discussion here, except a rotation of the mode in azimuthal angle. The microring devices are fabricated in 600 nm Si₃N₄ on about 3 μm thick thermal SiO₂ grown on a Si wafer. The PhCR devices have an outer ring radius of about 25 μm and an average ring width of about 2 μm. The modulation period is about 228 throughout the ring and is designed to create a mode splitting for the mode with an azimuthal mode number of m equals about 124.

The fundamental transverse-electric-like mode with this targeted mode number has a resonance frequency of around 148 THz for these PhCR devices, as shown in FIG. 37, with A from 0 nm (top) to 275 nm (bottom). The mode splitting, namely, the frequency separation between these two modes, increases for A from 0 nm to 100 nm, and then decreases and folds at A of 225 nm, and then reopens again. The quality factors (Qₜ) remain high, around a million or so throughout these devices, as shown in the right panel. The equation used is 1/Qₜ=1/Q₀+1/Q_{c}, where Q₀ and Q_{c} are intrinsic and coupling quality factors. The contribution of the splitting to the total linewidth is not counted in at 225 nm for consistency with other data points. Generally, high-Q rings lead to better linewidth for the IL laser. For OPO, typically a Q above about 105, and ring diameter less than about 1 mm is preferrable.

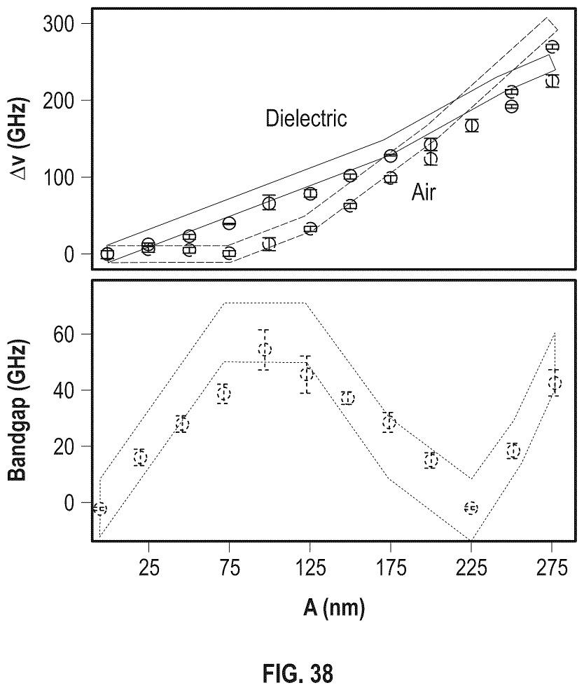

The mode splitting reflects the bandgap of the PhCR devices, but it is difficult to identify which one is the ‘dielectric’ and ‘air’ modes, as illustrated in FIG. 35. In aspects, it is possible to tell from high-resolution images together with the device pattern, but it is challenging to do so, particularly considering that the light is at 2 μm. To identify the mode property, simulation results are analyzed with the measured shifts of frequencies to those in the control (A=0 nm) devices, as well as the bandgap, in FIG. 38. The error bars represent one-standard-deviation uncertainty of the laser frequency for multiple scans. The shaded areas are from 3-dimensional finite-element-method simulations, with the width representing the resolution of the simulation. The experimental result is in good agreement with the simulation, and the ‘dielectric’ mode and ‘air’ mode can be unambiguously identified. The initial flatness of the ‘air’ mode in the measured data is captured by the simulation too, giving high confidence to trust the simulation model and results. FIG. 38 demonstrates that the ‘dielectric’ and ‘air’ band has a flip in the PhCR device set tested, following the illustration of band physics shown (purple) in FIG. 38.

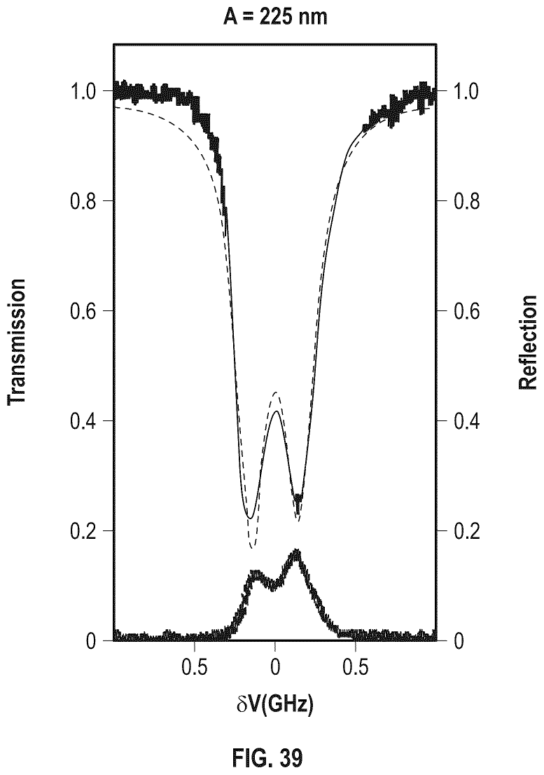

Referring to FIG. 39, the zoom-in transmission for the device with A=225 nm, where the bandgap is closed to be within its cavity linewidth, is shown. The intrinsic optical quality is fit to be (9.24±0.05)×10⁵, with the uncertainty indicating 95% confidence range of the nonlinear doublet fitting.

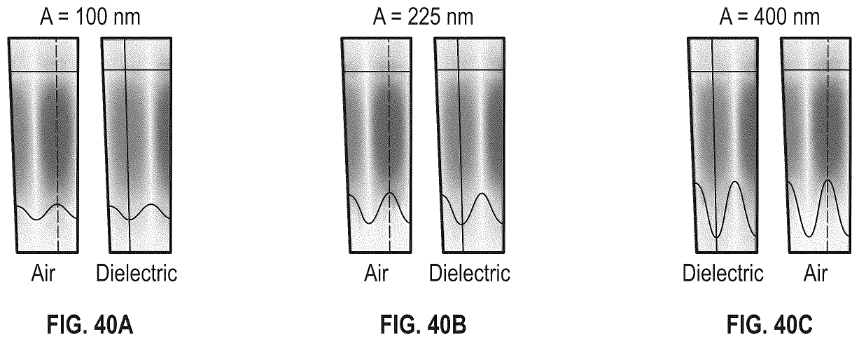

Referring to FIGS. 40A-40C, six mode profiles from a top view, that is, the dominant electric field in intensity and phase of the ‘dielectric’ and ‘air’ band-edge modes before, at, and after the band flipping, are shown. Red and blue indicate the positive or negative direction of the electric field, and the darkness of each color indicates the field amplitude. In larger modulation A=400 nm, the ‘dielectric’ mode has a larger mode volume than the ‘air’ mode, which aligns with the common understanding in grating or photonic crystal. At A=225 nm, the ‘dielectric’ mode and the ‘air’ mode have similar mode volume, though their antinodes are sitting in the widest and narrowest part of the ring, respectively. Considering the overall unit cell as a whole is important, and a function with an effective refractive index at thin slices is oversimplifying the experience of the light.

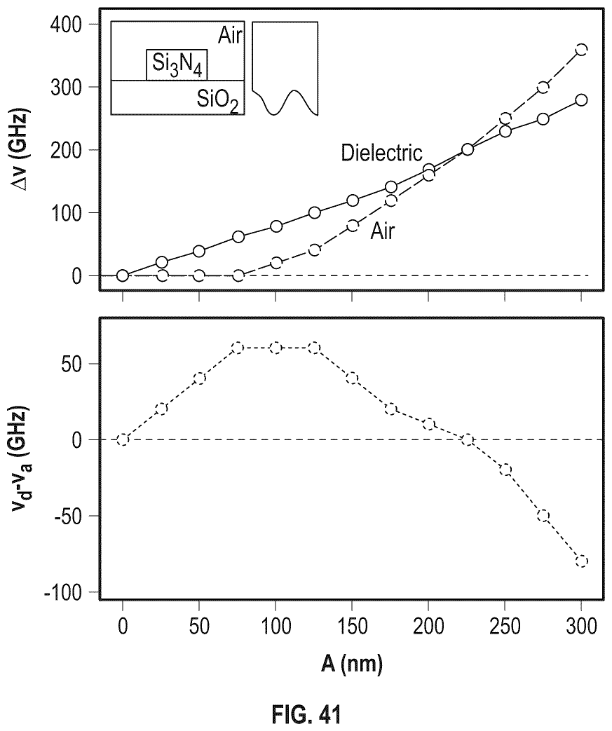

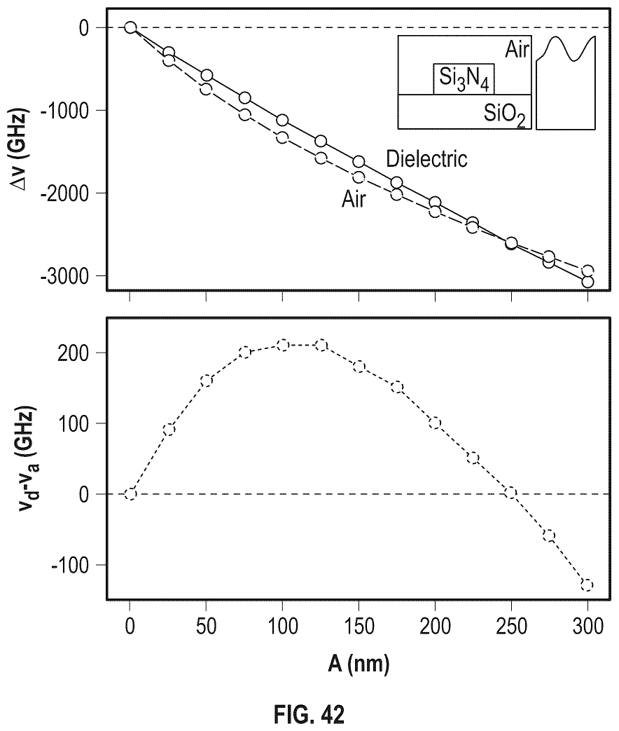

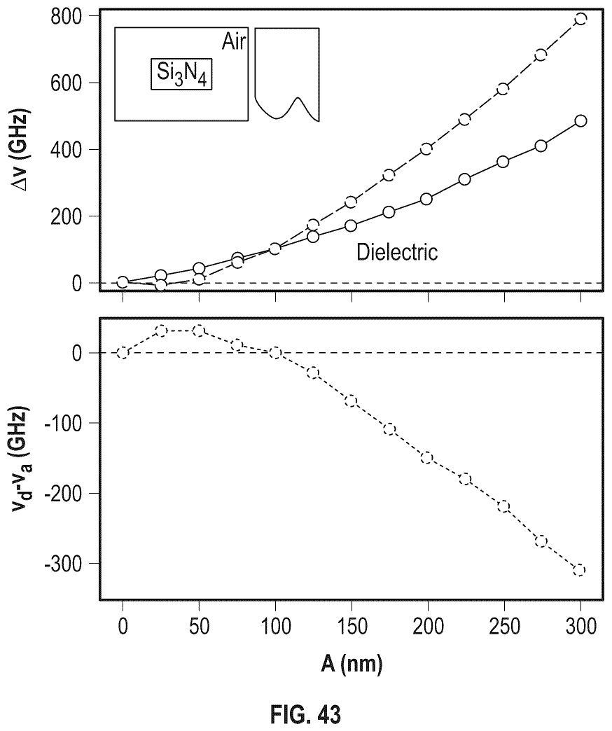

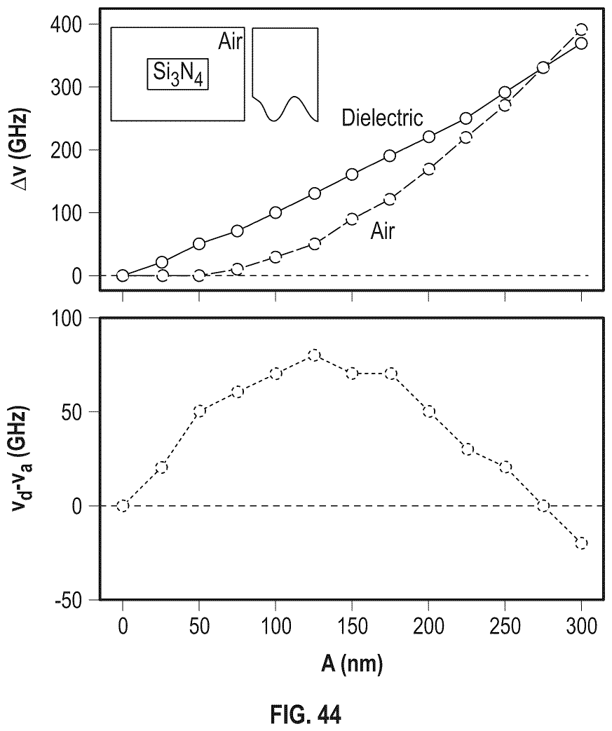

Referring to FIG. 41, the previous simulation result is re-plotted, where the PhCRs have a SiO₂ substrate. Referring to FIG. 42, the results with air cladding both top and bottom are shown. The bandgap closing point shifts A from 225 nm to 275 nm, yet the overall trend stays the same. Referring to FIG. 43, the PhCRs have outside ring radius modulations, whereas in FIG. 44, both inside and outside ring radii are modulated. In both cases, the bandgap closing point is around 250 nm. The frequencies of both ‘dielectric’ and ‘air’ modes shift to smaller frequencies in a similar way, as the outside ring radius modulation has a greater effect on the whispering gallery modes than the inside ring radius modulation.

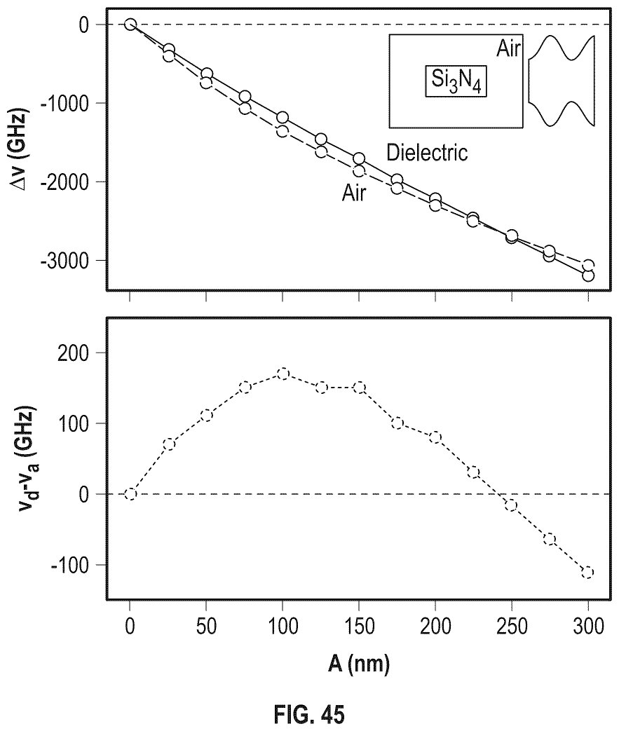

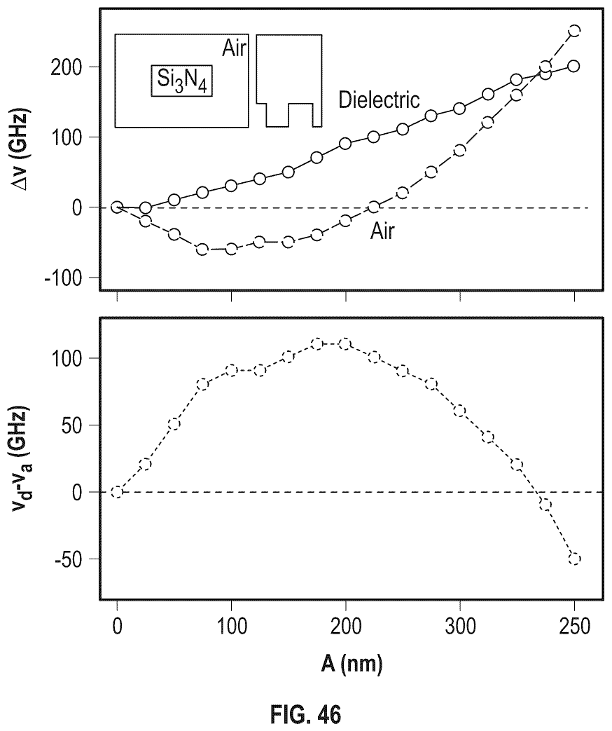

Referring to FIGS. 45-46, a ‘folded’-sinusoidal shape PhCRs and square-grating PhCRs are shown. For these six simulated geometries, the ‘dielectric’ mode shifts its frequency linearly versus the modulation amplitude A, while the ‘air’ mode has a quadratic dependence on the modulation amplitude.

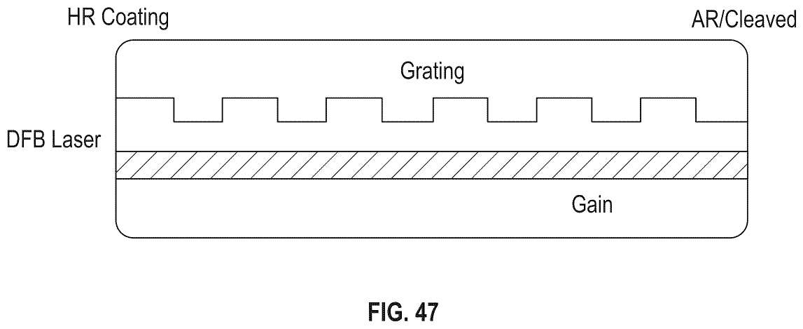

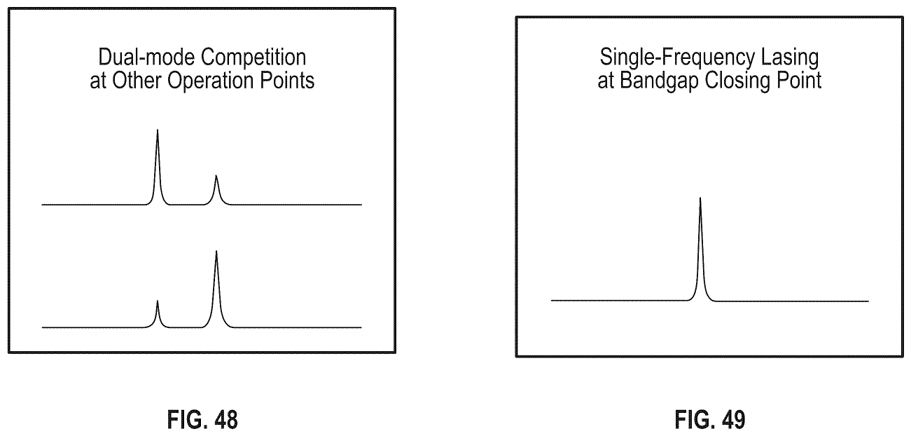

Referring to FIGS. 47-49, a distributed feedback (DFB) laser has a cleaved facet as a laser output, which leads to a random phase and, thus dual-mode competition. In aspects, the problem may be bypassed when two modes are degenerate in frequency.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for injection locking, comprising:
a light source configured to pump a first color light; and
a device configured to enable injection locking, the device including:
a waveguide configured to couple to the light source; and
a microring resonator coupled to the light source via the waveguide, wherein the microring resonator is a photonic crystal ring configured to enable injection locking, and
wherein the microring resonator is configured to operate at a bandgap closing point, where reflection at a single frequency occurs.

2. The system of claim 1, wherein the microring resonator is configured to generate a coherent second color light and a coherent third color light.

3. The system of claim 2, wherein the generation of the coherent second color light and the coherent third color light is based on optical parametric oscillation.

4. The system of claim 2, wherein the coherent second color light and the coherent third color light is a different color than the first color light.

5. The system of claim 3, wherein the optical parametric oscillation and the injection locking is performed on a same device.

6. The system of claim 1, wherein the microring resonator includes:
a layer comprised of silicon nitride, the layer including a ring width, the layer including a first side and a second side;
a substrate comprised of silicon dioxide disposed on the second side of the layer; and
a cladding comprised of air disposed on the first side of the layer.

7. The system of claim 1, wherein the microring resonator and the waveguide are on a common substrate.

8. The system of claim 7, wherein the waveguide outputs a signal wave including a signal mode and an idler wave including an idler mode.

9. The system of claim 1, wherein the first color light includes a pump mode.

10. The system of claim 1, wherein the photonic crystal ring includes a grating as a photonic crystal structure.

11. The system of claim 10, wherein the grating includes periodical modulation in one dimension.

12. The system of claim 1, wherein the microring resonator includes at least one of rods, slits, or microgears.

13. A device configured to generate a coherent second color light and a coherent third color light, the device comprising:
a waveguide configured to couple to a light source; and
a microring resonator coupled to the light source via the waveguide, the microring resonator configured to generate a coherent second color light and a coherent third color light, the microring resonator including unit cells.

14. The device of claim 13, wherein the generation of the coherent second color light and the coherent third color light is based on optical parametric oscillation.

15. The device of claim 13, wherein the microring resonator is configured for injection locking and to operate at a bandgap closing point, where reflection at a single frequency occurs.

16. The device of claim 13, wherein the microring resonator includes:
a substrate comprised of silicon dioxide disposed on a second side of the unit cells; and
a cladding comprised of air disposed on a first side of the unit cells,

17. The device of claim 16, wherein the unit cells are comprised of a material with an index of refraction higher than an index of refraction of the substrate.

18. The device of claim 13, wherein the microring resonator and the waveguide are on a common substrate.

19. The device of claim 13, wherein the microring resonator includes a grating as a photonic crystal structure.

20. A device configured to enable injection locking, the device comprising:
a waveguide configured to couple to a light source; and
a photonic crystal ring configured to enable injection locking, the photonic crystal ring coupled to a light source via the waveguide,
wherein the photonic crystal ring is configured to operate at a bandgap closing point, where reflection at a single frequency occurs.
